(19) United States
(12) Patent Application Publication
(10) Pub. No.: US 2006/0119175 A1
(43) Pub. Date: Jun. 8, 2006

(54) Undercarriage system of multiple endless chain links of a tracked wheel type

(76) Inventor: Enrique Garza, Huntley, NE (US)

Correspondence Address: ENRIQUE GARZA, 1719 DIVISION AVENUE, HUNTLEY, NE, 68971, US

(21) Appl. No.: 11/056,646

(22) Filed: Feb. 11, 2005

Related U.S. Application Data
(60) Provisional application No. 60/633,450, filed on Dec. 7, 2004.

(51) Int. Cl. B62D 55/08

(52) U.S. Cl. 305/157

(57) ABSTRACT

An improved traction with automatic operation of the undercarriage system into terrain to various terrain including amphibiously having a resilient chainlink chasis FIG. 1 of resilient metal or resilient plastic or resilient composite or the combination thereof employing a multitude of resilient traction penetrators FIG. 3 chainlink side ends angled downward for greater traction FIG. 22 resilient enlongated traction penetrator FIG. 8 and 9 resilient flap traction penetrators FIG. 37 and 38 with rubber traction pads capable to quick release and attach to chainlinks with optional pad materials the penetration assembles systems attach unto chainlink chasis the multiple penetrators work together simeoustaneously flexing or exstending and retracting automatically dictated by the combination of vehicle weight and temperment of terrain and the automation is manipulated in combination with resilient technology principals and resilient roller wheels activater and diactivator FIG. 23 and 26 and 49 figure links adaptable unto rubber wheel assemblies

### RELATED APPLICATIONS

The present application is a continuation application of U.S. provisional patent application, Ser. No. 60/ 633450, filed Dec. 7, 2004, for UNDERCARRIAGE SYSTEM, by Enrique Garza, included by reference herein and for which benefit of the priority date is hereby claimed.

The present application is related to U.S. Pat. No. 2,141,421, issued Dec. 27, 1938, for WILLIAM S TAYLOR, by FOLDING CLEAT OR GROUSER, included by reference herein.

The present application is related to U.S. Pat. No. 3,934,664, issued Jan. 27, 1976, for STEERING MECHANISM FOR TRACK VEHICLES, by Jorma Toivo Tapani Pohjola, included by reference herein.

The present application is related to U.S. Pat. No. 4,119,356, issued Oct. 10, 1978, for VEHICLE AND ENLESS TRACK STRUCTURE THEREFOR, by Jorma Toivo Tapani Pohjola, included by reference herein.

The present application is related to U.S. Pat. No. 5,881,831, issued Mar. 16, 1999, for MULTI-TERRAIN AMPHIBIOUS VEHICLE, by William B, Harvey, included by reference herein.

Federally sponsered research: Not applicable

Sequence listing or program: Not applicable

Field of search : 305,280/28.5,301/45+,474,180/10,926+, 172/17+,124+,143+

### FIELD OF THE INVENTION

The present invention relates to . . . and, more particularly, to . . . An improvement of traction and capabilities for various vehicles with endless chain links that interconnect to a track wheel system also having ability to convert a rubber wheel system to a track capability by attachment to single or multiple wheels

### BACKGROUND OF THE INVENTION

Tracked vehicles mainly have a fair weather type efficiency limited in bad weather and a liability in certain slopes in any weather condition. it is also dependent on the weight of the vehicle for traction, therefor this is why a tracked vehicle sinks and get stuck on too soft of a terrain and slips and slides on winter ice and when a vehicle is negotiating a slope, it loses traction when the center of gravity shifts. there is a multitude of track designs for a multitude of various vehicles because there is no one track design that is applicable to most or all the various types of vehicles. there is a logistic and exspense created for the multitude of various tracks. some track designs require hands on reconfiguration in the field with the vehicle immobile when changing to different terrains and the speed of reconfiguration is dependent on weather some track designs are so specialized that it losses its effieciency dramatically out of the purpose terrain.

Solutions in track design history utilized a wider footing, this increased traction surface while minimizing sinking on soft terrain. another track design utilized rubber pads attached to the steel links to prevent unwanted road damages. another design was to enginneer with utmost effeciency to specialize to the enviroment it was mostly used on example snow, swamp. amphibious enviroments. snow, swamp, and amphibions incorporated similar design of latterally long blades on every link, this created an oar principal. another design utilized an all rubber belt track design therefor giving a lighter and quieter capability. amphibious propulsion shifted from tracks to seprate systems such as water pumps and water jets or turbines therefor giving a faster speed ratio of effecincy.

The shortcomings of history solutions are the wider the track links the heavier in which feul economy is taxed. the rubber pads design are in the way of steel biting links in certain enviroments therefor hindering traction. specialized tracks are limited outside it's design enviroment. U.S. Pat. No. 2,141,421 requires a hands on reconfiguration with a tool, using time to manipulate every individual link to it's desired position with the vehicle at a stopped or parked status, this is a disadvantage in certain weather and terrain conditions, being also time cosuming. U.S. Pat. No. 4,119,356 is a specialized design limited to it's design purpose of turning. the amphibious track design of multiple oars of latterally enlongated blades were of limited effeciency because water level was not always level, so as the blades propel the vehicle at the bottom cycle of the track revolution, when the top revolution with unstable choppy waters, the blade oars counteracted the forward momentum by pushing water into the opposite direction like as U.S. Pat. No. 5,881,831 page one FIG. 2 number 25 in which uses the blade oar principal with a greater mass of material. amphibious propelment designs of water pumps and now water jet turbines, sacrifce vehicle space with increased weight with limited usage, because amphibious vehicles spend more time out of water than in water, therefor as soon as the vehicle gets out of water the seperate propulsion system becomes dead weight. the all rubber belt designs are prone to faster wear and tear and ripping apart, when discarded it is wastfull of much rubber.

It is therefore an object of the invention to . . . Incorporate more capability and versatiliy in a standard comparable size of undercarriage system It is another object of the invention to . . . Make it self adjusting from trrain to terrain automatically to eliminate field phyisical reconfigeration.

It is another object of the invention to . . . to save vehicle space and weight, by bringing back to the undercarriage system the amphibious capabiliy with a more effieciency, or to compliment an allready in place propulsion system.

It is another object of the invention to . . . To make a new use of track design for a single unit vehicle that incorporates the all terrain, the snowmobile and the water ski jet capabilities for recreational, military and resue.

It is another object of the invention to . . . Have capabilities to change a rubber wheel system into a track system by attachment to existing rubber wheel system.

It is another object of the invention to . . . Eliminate the all rubber belt track design to minimize rubber waste, by obtaining a comparable flexability track design option.

It is another object of the invention to . . . Have track pads with easy quick release and replacement with various optional pad materials, according to vehicle especifications.

It is another option of the invention to . . . Have longtitude and side traversing traction capability with various multiple penetration systems.

It is another option of the invention to . . . Be applied to a greater number of various vehicles to minimize material logistics.

It is another object of the invention to . . . To create new uses for the internal wheel suspension that is part of the undercarriage system to various and all kinds of wheel systems.

It is another object of the invention to . . . To create new uses for the internal wheel suspension that is a part of the undercarriage system as a shock or impact suppressor to all kinds of shock prone systems like as the automotive bumpers.

It is another object of the invention to . . . To create new uses for the internal wheel suspension that is a part of the undercarriage system as a vibration damper to all kinds of systems prone to vibration.

It is another object of the invention to . . . To create new uses for the internal wheel suspension that is a part of the undercarriage system as a suppressor or buffer of sudden jolt or gravity trammas with a mutiple directional capability to all kinds of vehicle seats.

### SUMMARY OF THE INVENTION

In accordance with the present invention, there is provided . . . an undercarriage system employing resilient technology principals to manipulate automatically operation of transition from terrain to terrain including amphibiously also to substantially improve traction capabilities by employing a multitude of resilient penetrator traction devices which are attached to resilient chainlink chasis and the resilient material parts are of resilient metal or resilient plastic or resilient composites or the combination thereof and the undercarriage system is appliccable to a multitude and various kinds of vehicles as in commercial and military and recreation and rescue with also the belt track made adaptable to attach to predetermine single or rubber wheel assemblies

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top view of a resilient chainlink chasis with a view of multiple assembly slots and connectors

FIG. 2 is a top view of a resilient chainlink chasis with perspective sectional slices;

FIG. 3 is a front view of a resilient chainlink chasis in unstressed or retracted status showing angled ends;

FIG. 4 is a sectional half cut view of a resilient flap penetrator assembly with hollow torsion rods that sleeve through in a unit connecting to transmission;

FIG. 5 is a top view of a resilient chainlink with assemblies attached to chasis;

FIG. 6 is an exploded view of a flap assembly parts in enlarged detail left side;

FIG. 7 is an exploded view of a flap assembly parts in enlarged detail right side;

FIG. 8A is a sectional view of a resilient flap penetrator illustration in unstressed or retracted status;

FIG. 8B is a side view of a flap transmission gearing with arrow directions towards exspansion or stressed position;

FIG. 9A is a sectional view of a resilient flap penetrator illustration in stressed or exspanded status;

FIG. 9B is a side view of a flap transmission gearing with arrow directions towards retracting or unstressed status;

FIG. 10 is an exploded view of an upper and lower flap penetrators and shaft retainer with slide through flap directions;

FIG. 11A is a top view of a flap geared ends connectig to flap transmission or sun gear;

FIG. 11B is a sectional view of a flap ends and transmission in side view;

FIG. 12A is a side view of a flap linkage that connects penetrator with flap assemblies;

FIG. 12B is a front view of a two flap linkages connected into one unit by a bar that is a part of flap assembly;

FIG. 13A is a side view of a leaf spring buffer linkage that is a part of flap assembly;

FIG. 13B is a top view of a leaf spring buffer linkage that is a part of flap assembly;

FIG. 14A is a side view of a slide gear that is part of flap assembly;

FIG. 14B is a top view of a slide gear that is a part of flap assembly;

FIG. 15 is a top view of a resilient chainlink with assemblies attached to chasis;

FIG. 16 is an exploded view of a resilient long penetrator assembly;

FIG. 17 is an exploded view of a resilient leaf spring cam lock assembly;

FIG. 18A is a top view of a resilient long penetrator;

FIG. 18B is a side view of a resilient long penetrator;

FIG. 18C is a front view of a resilient long penetrator;

FIG. 19 is a bottom view of a resilient cam lock assembly;

FIG. 20 is a front view of a resilient cam lock assembly;

FIG. 21A is a front view of a reilient cam lock working illustration showing reverse leaf spring in locked or depressed position by ring depressor;

FIG. 21B is a front view of a resilient cam lock working illustration showing reverse leaf spring is unlocked by cam lock exspander;

FIG. 22A is a side sectional view of a resilient chainlink chasis;

FIG. 22B is a side sectional view of a resilient chainlink chasis with long penetrator and cam lock assemblies both in retracted or unstressed position;

FIG. 22C is a side sectional view of a resilient chainlink chasis with long penetrator and cam lock assemblies both in depressed or stessed position;

FIG. 23A is a side view of an undercarriage with highlighted position of roller wheel depressor;

FIG. 23B is a side view of a resilient roller wheel depressor assembly;

FIG. 24A is a front half view of a resilient depressor ring assembly;

FIG. 24B is a side half view of a resilient depressor ring assembly;

FIG. 25 is a side view of a spring leaf of the depressor ring in depressed or stressed position;

FIG. 26A is a side view of an udercarriage with highlighted position of roller wheel exspander;

FIG. 26B is a side view of a roller wheel exspander;

FIG. 27 is a front half view of a roller wheel on chailink chasis exspander or depressor;

FIG. 28A is a side view of an undercarriage with highlighted internal wheel suspensions;

FIG. 28B is a side view of an internal wheel suspension assembly;

FIG. 29A is a side view of a resilient internal wheel suspension in unstressed position;

FIG. 29B is a side view of a resilient internal wheel suspension in stressed position;

FIG. 30A is an exploded view of an interlocking leaf springs of internal wheel suspension;

FIG. 30B is an enlarged detail view of an interlocking leaf spring grooves;

FIG. 31A is a half front and side view of an internal suspension case;

FIG. 31B is a half front and side view of an internal suspension guide plates;

FIG. 32A is a sectional half cut view of an internal suspension case with guide plates and axle a working illustration without the internal springs in one unit axle in unstressed position;

FIG. 32B is a sectional half cut view of an internal suspension unit in stressed position;

FIG. 33 is a side view of a working illustration of roller wheel depressor or exspander traveling over interconnected chainlinks depressing reverse leaf spring which inturn depressing long penetrator;

FIG. 34A is a top view of a sprocket that can be designed as two inside or two outside or four teeth option;

FIG. 34B is a top view of an interconnected chainlink with outsides in standard connection format and centered sprocket to interlock and ride over link shaft ends then over chasis sprocket slots then starting new repitition over shaft connector;

FIG. 35 is a top view of a lower flap with locking slot latches for pad assembly;

FIG. 36 is a sectional view of a lower flap and locking latches;

FIG. 37A is a side view of a pad assembly;

FIG. 37B is a top view of a pad chasis showing latch pins and latch pin lock;

FIG. 38 is a sectional view of a pad assembly;

FIG. 39A is a top view of a work illustration of latch pins of pad assembly connecting to lower flap slots the begining of alighnment sequence;

FIG. 39B is a top view of a sequenced of the slide and locking position;

FIG. 39C is a top view of a pad assembly pins locked into place on the lower flap latches;

FIG. 40A is a side view of a centrifical penetrator an adapter unit for chainlinks that are strapped to rubber wheel assemblies this penetrator is in retracted or unstressed position;

FIG. 40B is a side view of a centrifical penetrator in exstended or stressed position;

FIG. 41A is a top view of a guide block with bearings and penetrator;

FIG. 41B is a side view of a guide block with bearing and penetrator;

FIG. 41C is a top view of a resilient penetrator and shaft connector;

FIG. 42 is an elevational right view of an alternate embodiment of resilient chainlink chasis with split or forked ends;

FIG. 43A is a side view of a fork illustration of stressing or flexing;

FIG. 43B is a side view of a fork illustration of independent stressing or flexing;

FIG. 44A is a top view of a forks having bearings within universal joint case connecting while maintainig independent flexing;

FIG. 44B is a side view of a fork equipped with universal joint traversing uphill;

FIG. 45A is a front view of an alternate embodiment of chainlink chasis coil spring loaded;

FIG. 45B is a bottom view of a chasis showing coil springs and guide blocks in center;

FIG. 46A is a front view of an alternate chainlink chasis leaf spring loaded;

FIG. 46B is a bottom view of a chasis showing leaf spring and centered leafspring block;

FIG. 47A is a front view of an alternate embodiment chainlink chasis;

FIG. 47B is a front view of a multitude of leaf springs that attaches to chasis frame;

FIG. 47C is a top view of a leaf spring showing slot holes for fastener to combine leafs;

FIG. 48A is a top view of a top plate on optional chasis designs for when a sturdy or heavy duty base is required this top plate has centrifical penetrator for rubber wheel assemblies;

FIG. 48B is an elevational right view of a top plate with forked chasis;

FIG. 49A is a front view of an adjustable top plate for rubber wheel assemblies this design can be incorporated in combination with FIG. 37 and 39 latch system onto top plate chainlink FIG. 48;

FIG. 49B is a side view of a rubber wheel assembly with links interconnected and strapped and secured with chains;

FIG. 50A is a top view of a brace adjuster;

FIG. 50B is a side view of a brace adjuster;

FIG. 51 is a top view of a slide chasis;

FIG. 52 is a sectional view of a slide chasis;

FIG. 53A is a perspective view of a connection illustration beginning sequence of brace adjuster through slide chasis;

FIG. 53B is a perspective view of a completed connection sequence;

FIG. 53C is a front view of an adjusting sequence for multiple wheel assemblies;

FIG. 54A is a top view of an alternate embodiment of penetrator with longer penetration;

FIG. 54B is a front view of a longer penetrator;

FIG. 55A is a front half view of an alternate depressor for roller wheel;

FIG. 55B is a perspective view of an alternate deppressor showing different stages of parts;

FIG. 56 is a front view of a second alternate deppressor showing shaft design;

FIG. 57 is a side half view of a third alternate deppressor showing clip on interlocking system;

FIG. 58A is a front half view of a leaf spring ring showing clip on slots;

FIG. 58B is a side view of a leaf spring ring;

FIG. 59A is a front half view of a leaf spring tensioner with slots and end bearrings;

FIG. 59B is a side view of a leaf spring tensioner;

FIG. 59C is a perspective view of a spring tensioner end and bearring parts;

FIG. 60 is a perspective view of a new use embodiement of internal wheel suspension on spoked type wheels;

FIG. 61 is a top view of a new use embodiement of internal wheel suspension as impact suppressor showing in bumber design;

FIG. 62 is a perspective view of a new use embodiement of internal wheel suspension as vibration and impact suppressor showing rubber sleeve on axle and rubber bearings;

FIG. 63A is a perspective view of a new use embodiement of internal wheel suspension as multiple directional impact suppresor;

FIG. 63B is a perspective view of a capable directions of the multiple directional unit;

FIG. 63C is a cross sectional view of a chasis or case;

FIG. 63D is a sectional view of a chasis showing open end for axle free movement;

FIG. 63E is a side view of a multiple directional impact suppressor showing three systems with their own directions as one unit;

FIG. 63F is a front view of a multiple impact suppressor showing axle attached;

FIG. 64A is a perspective view of a new use embodiement for multiple impact suppressor on chairs or seats showing frame with impact suppressing adjustable head rest;

FIG. 64B is an exploded view of a securing and adjusting mount rack for seats; and

FIG. 64C is a sectional view of a slide rack one part sliding into the other.

For purposes of clarity and brevity, like elements and components will bear the same designations and numbering throughout the FIGURES.

### DESCRIPTION OF THE PREFERRED EMBODIMENT

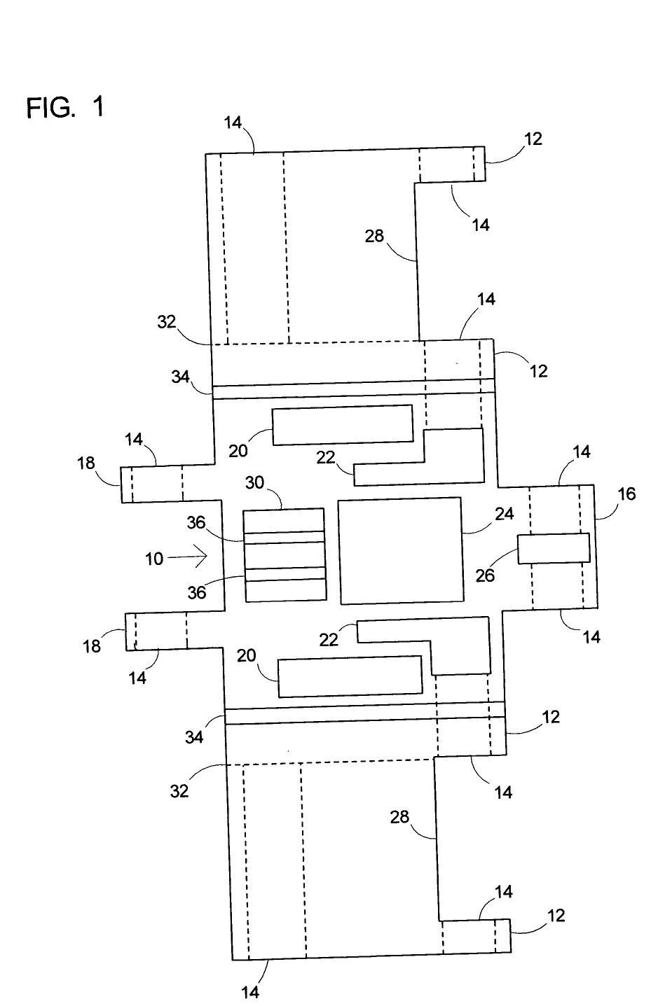

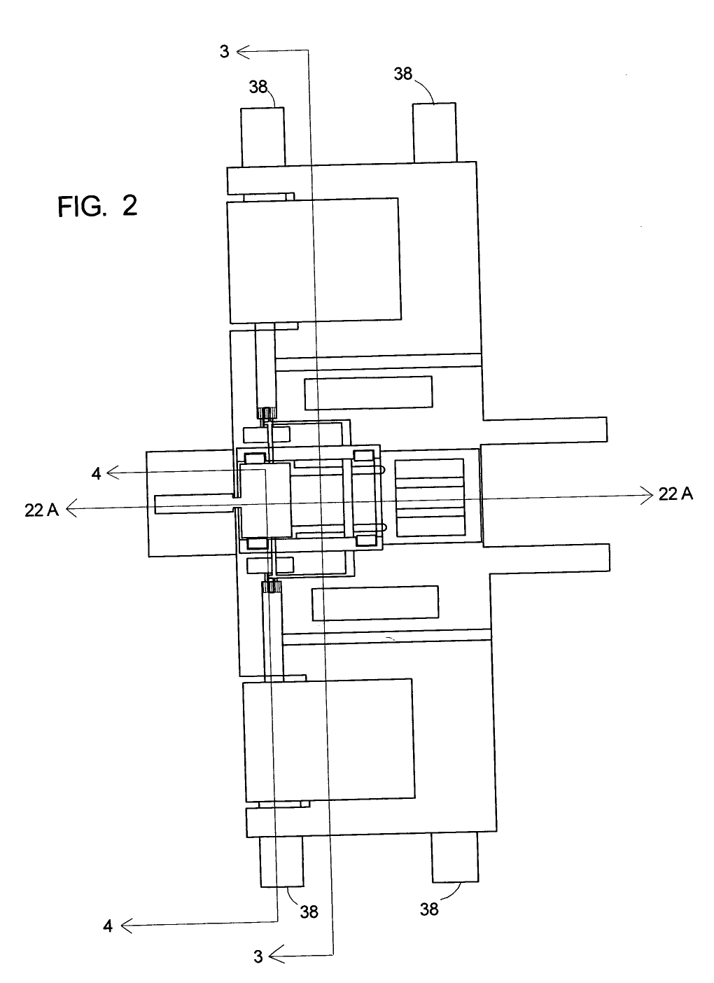

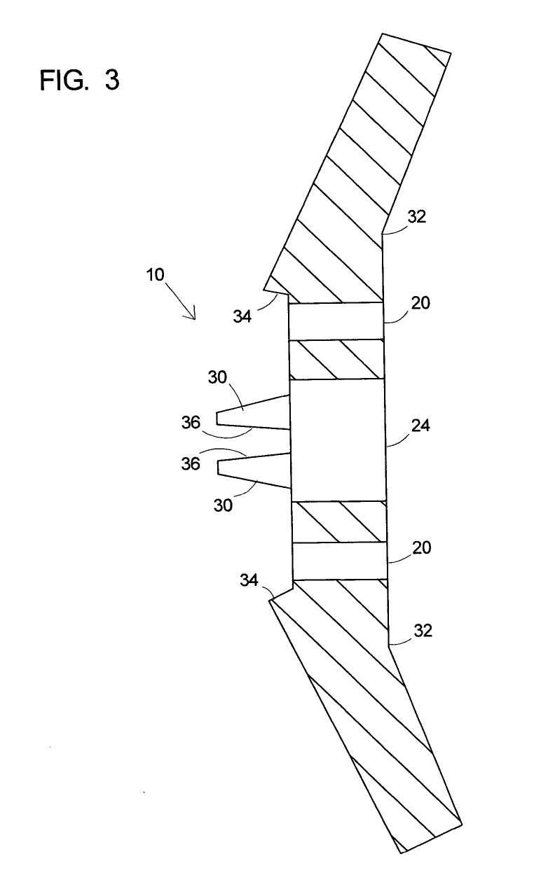

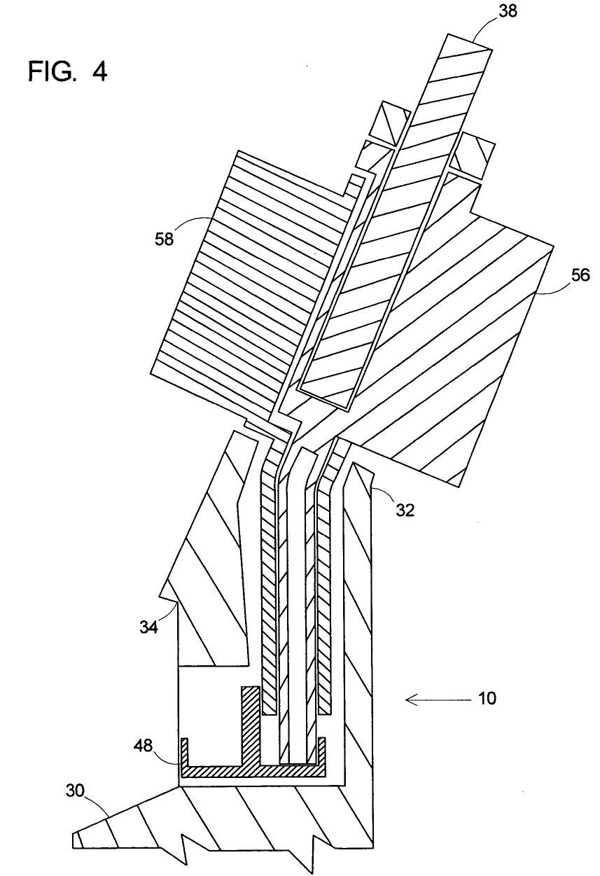

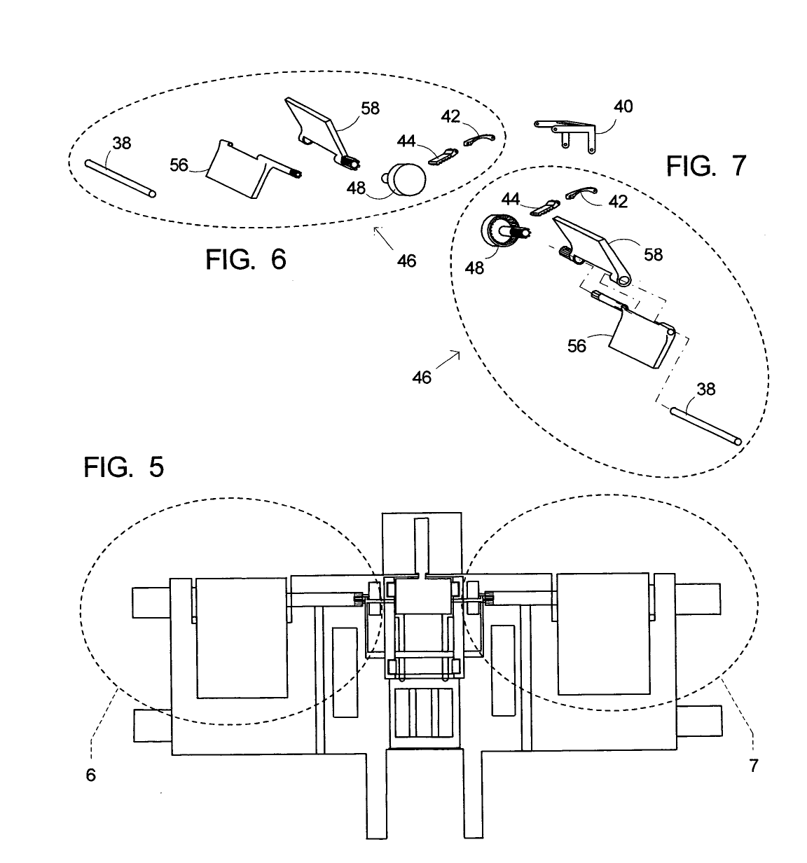

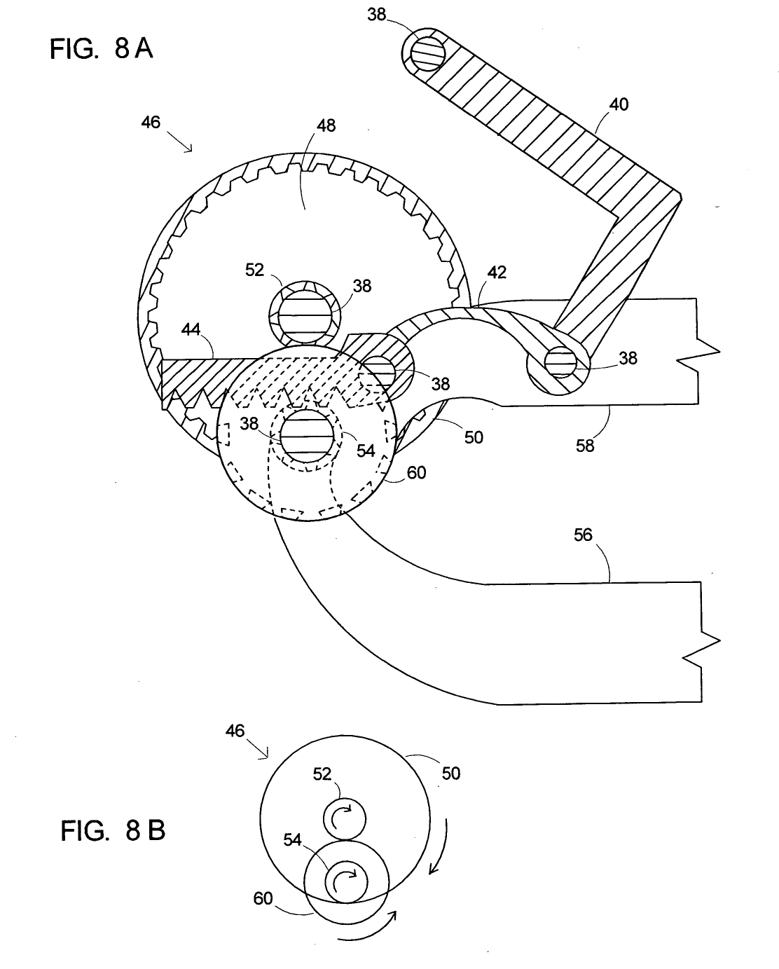

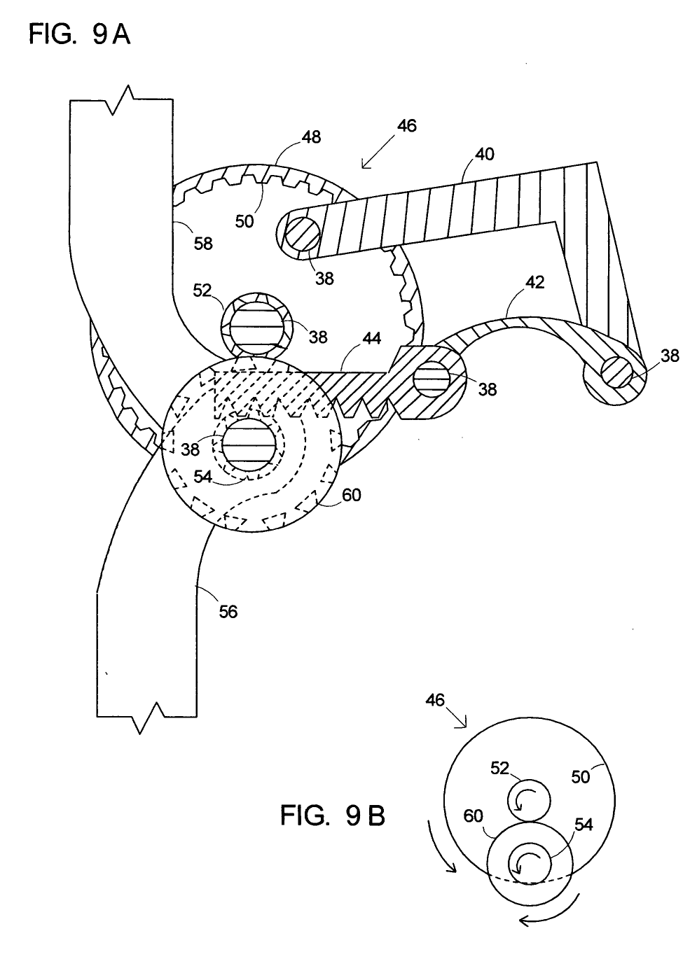

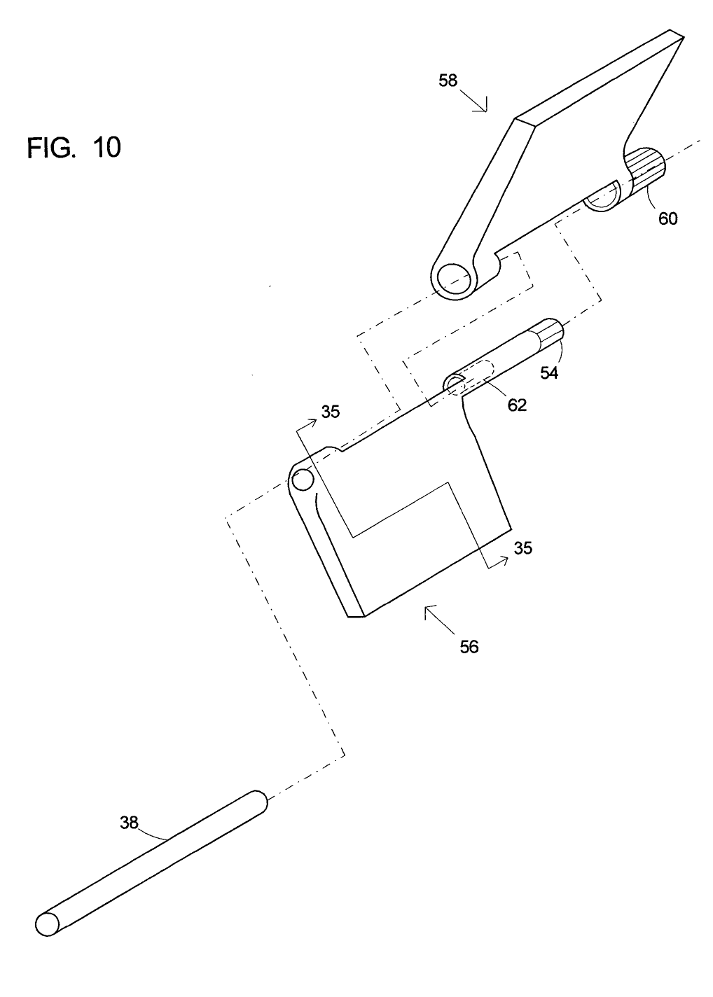

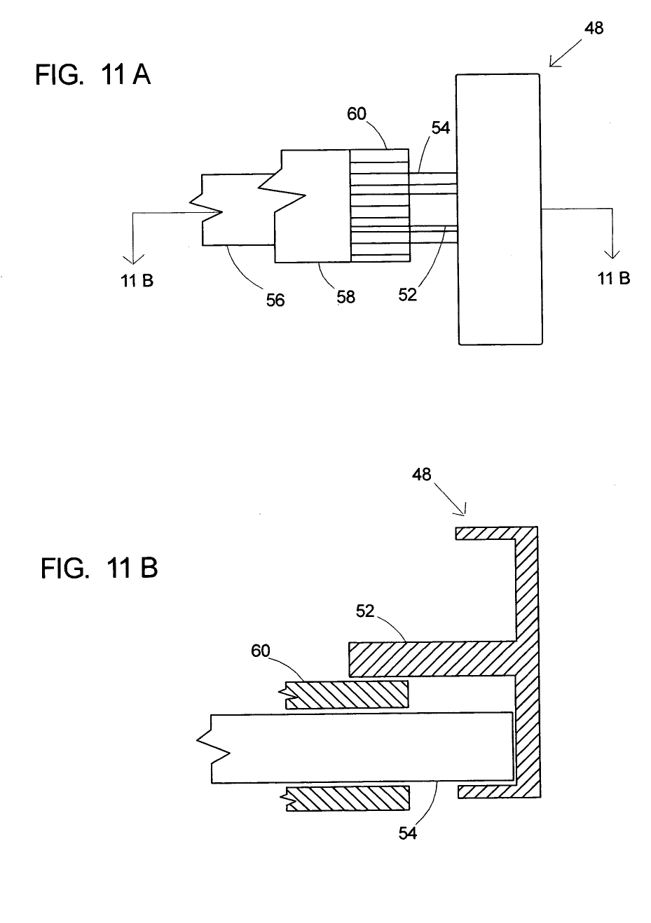

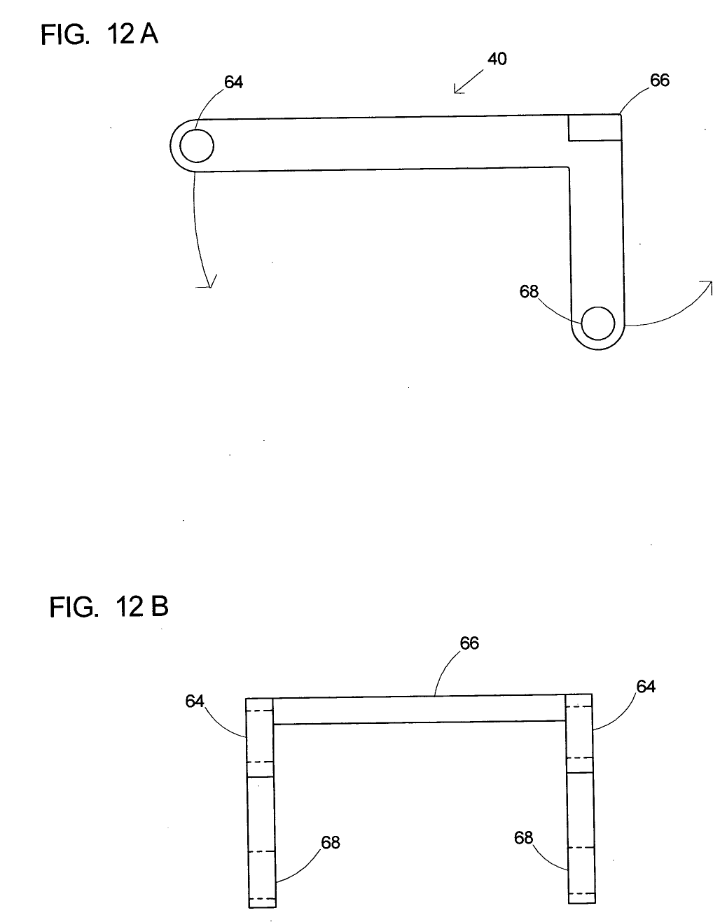

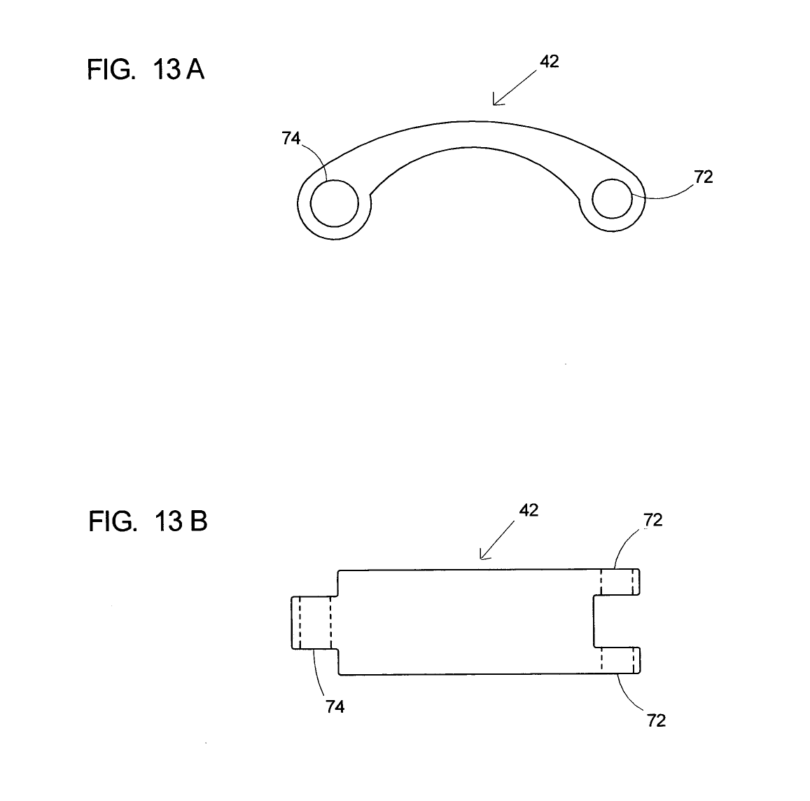

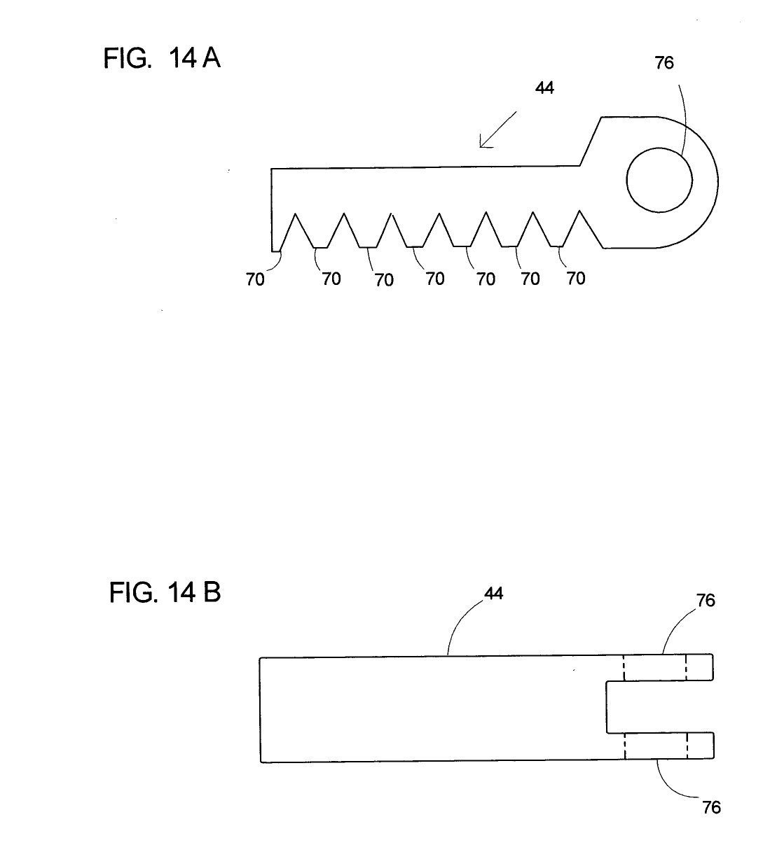

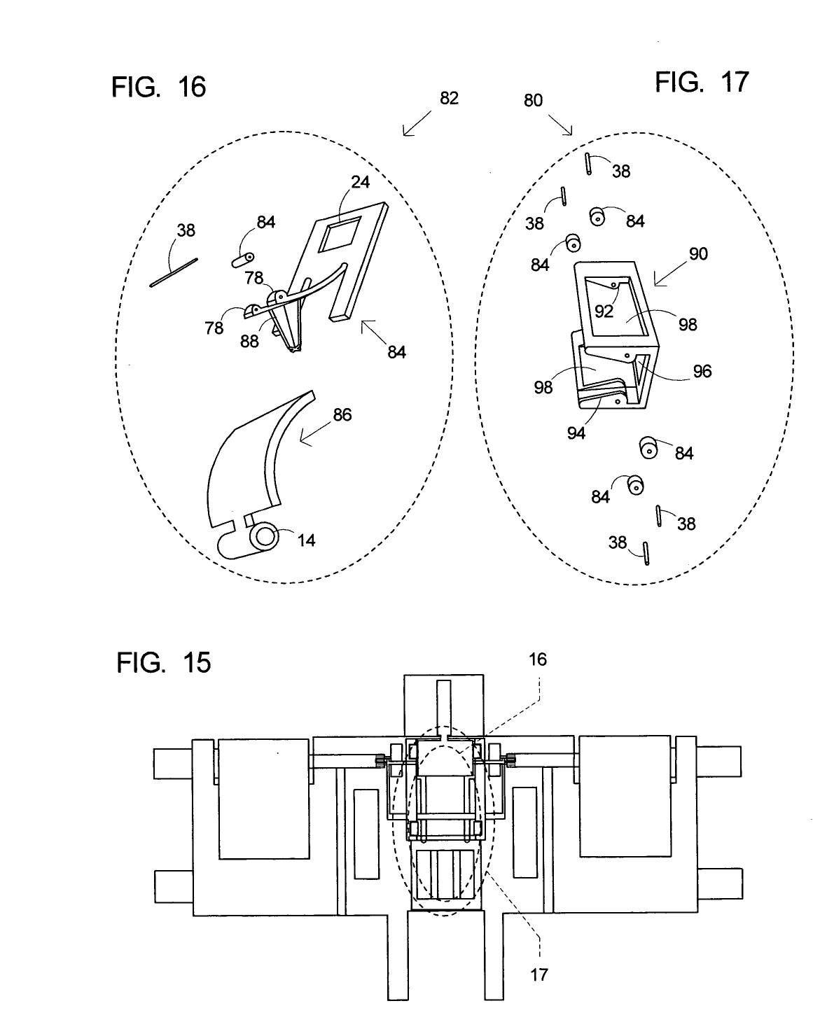

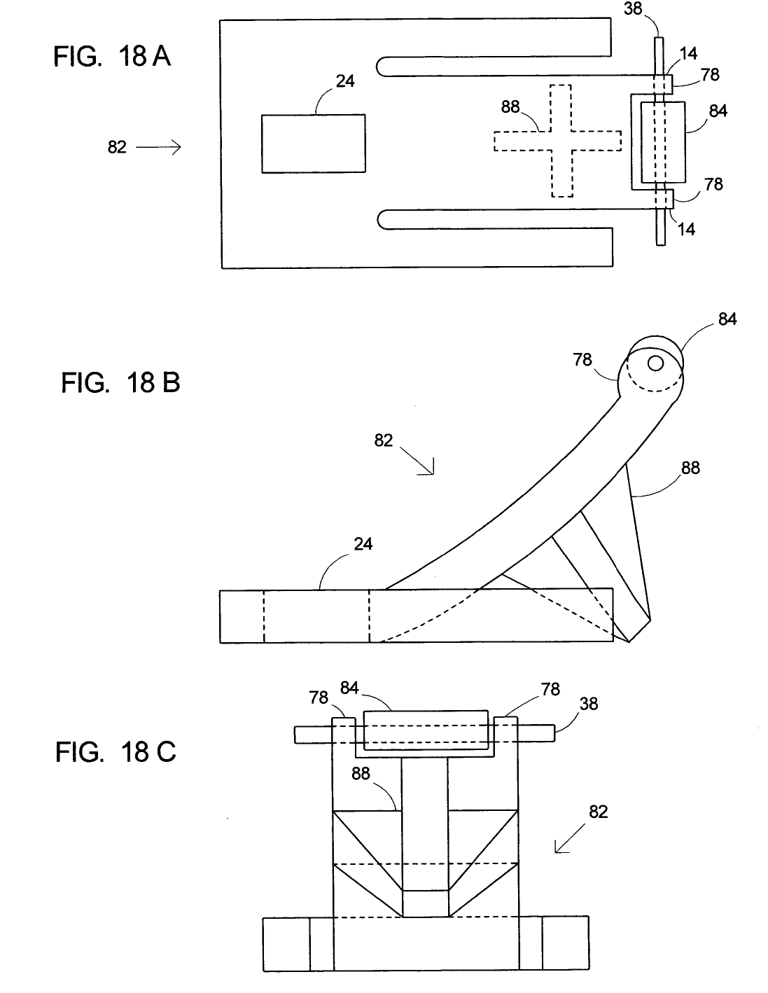

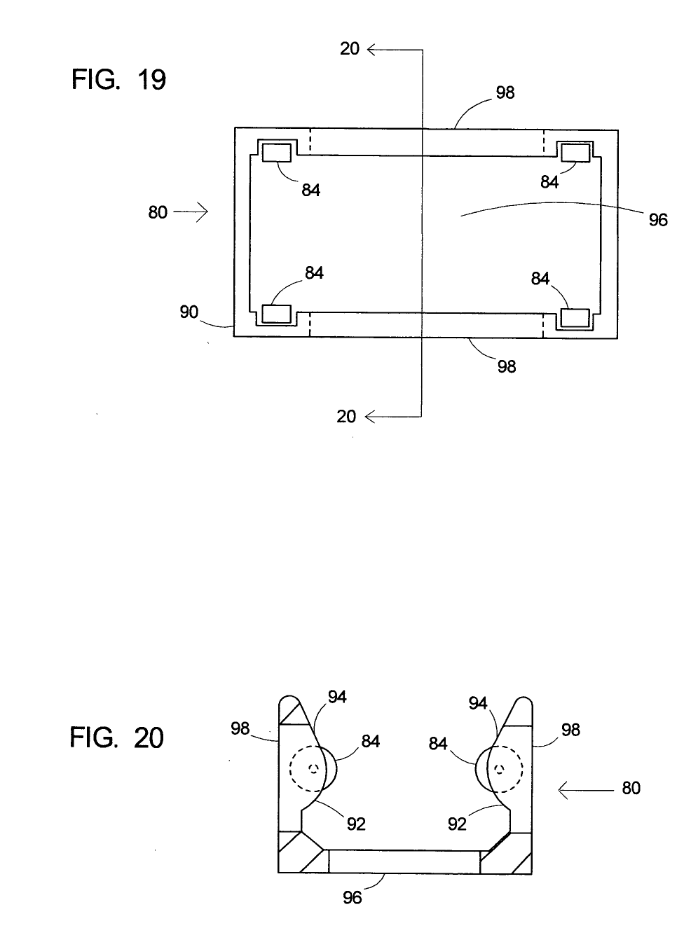

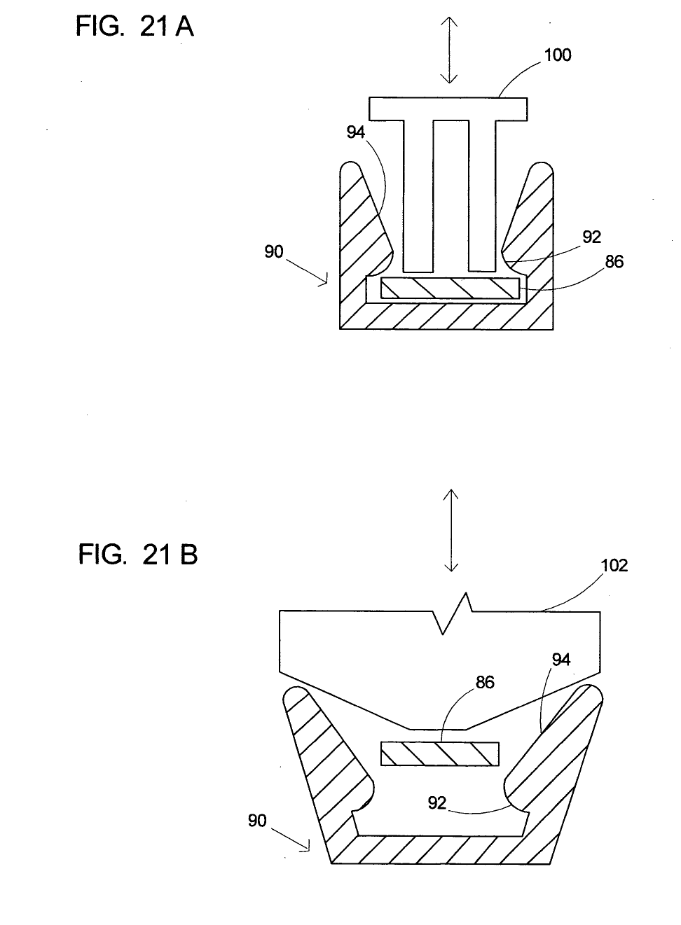

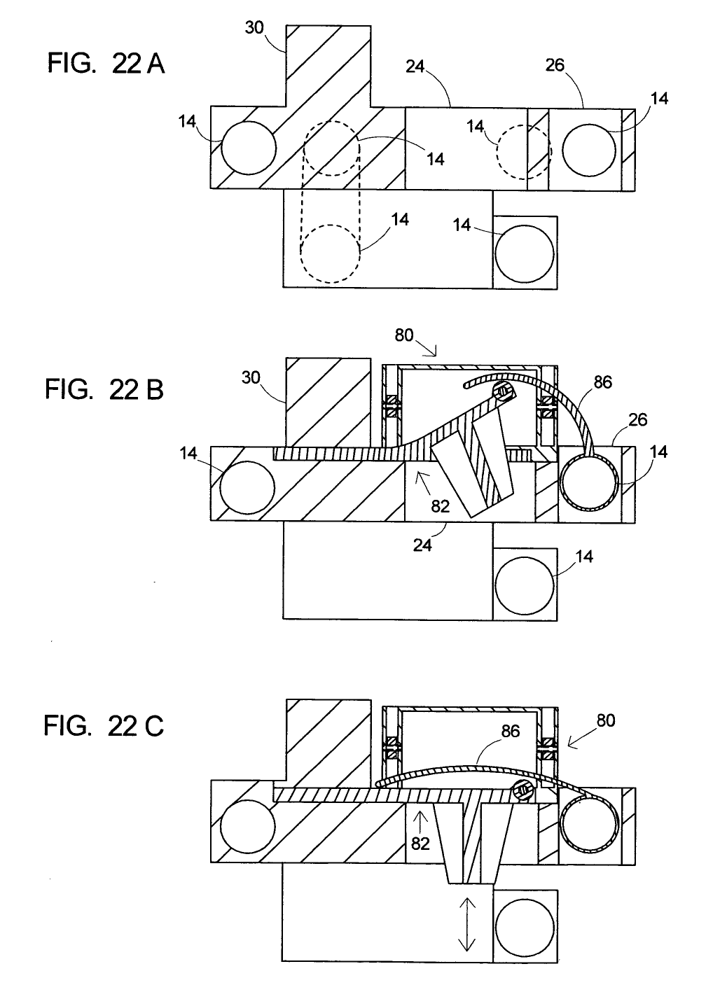

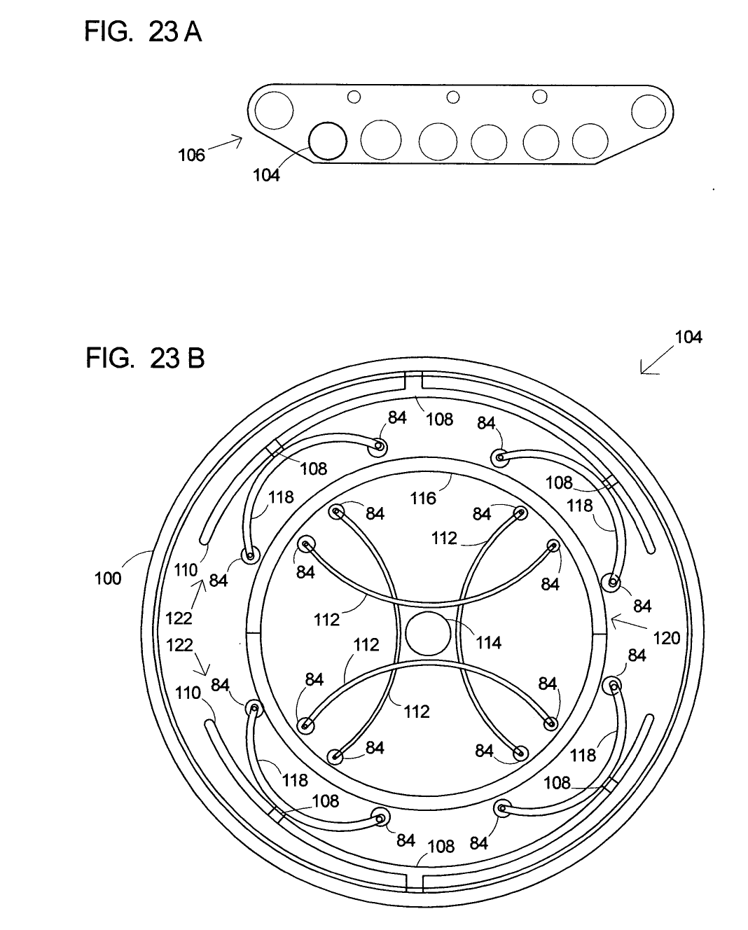

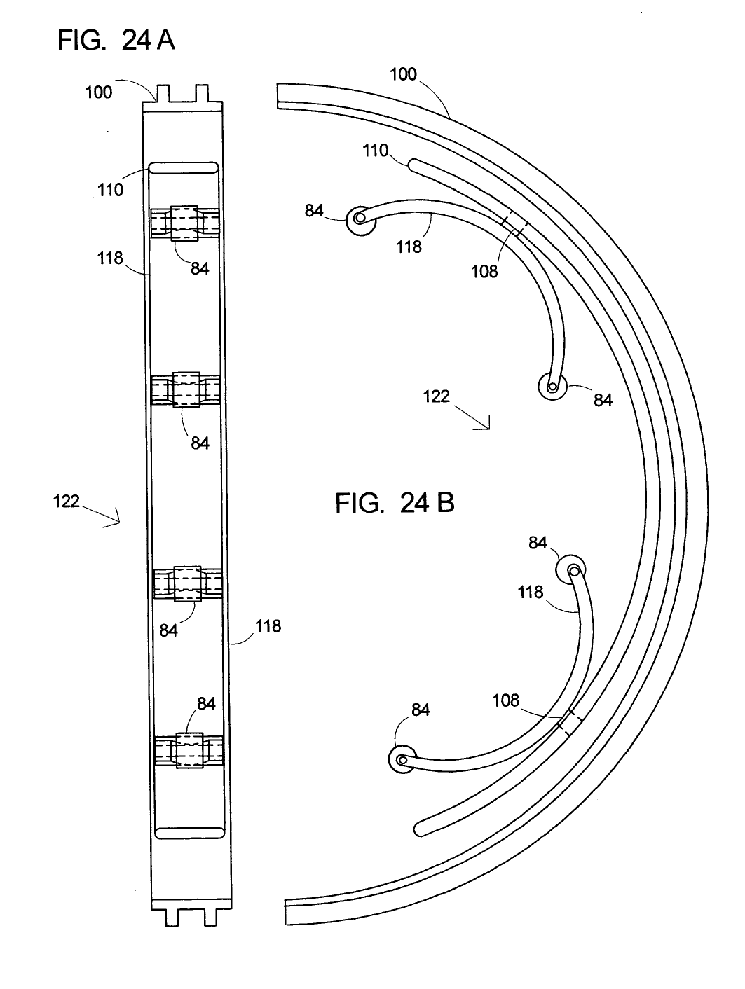

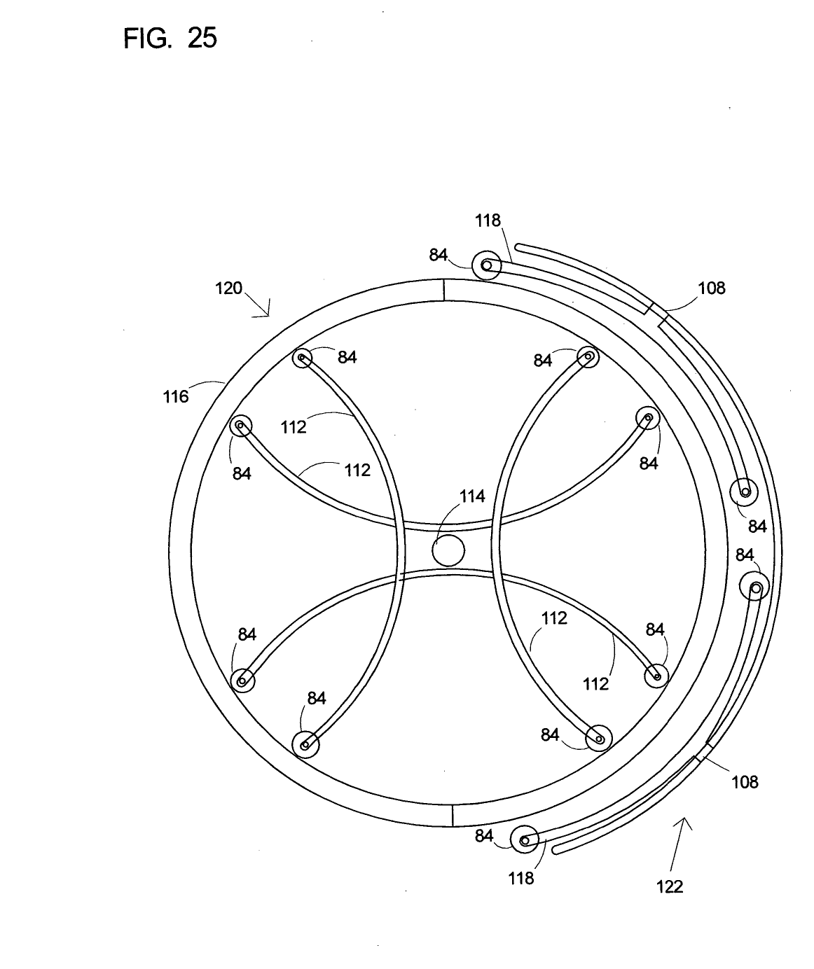

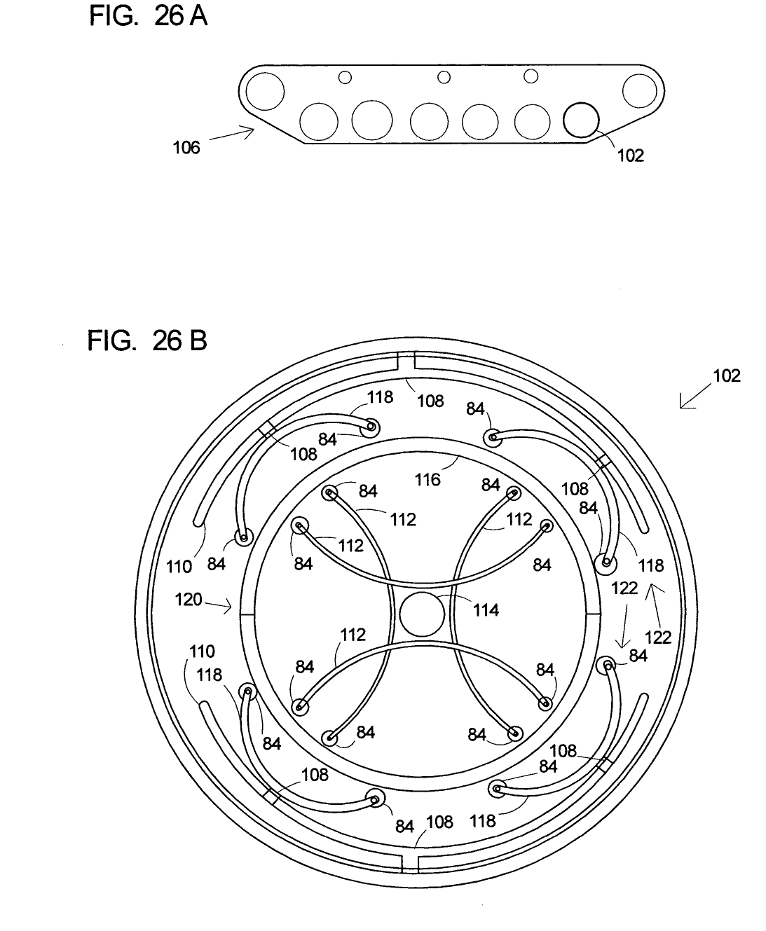

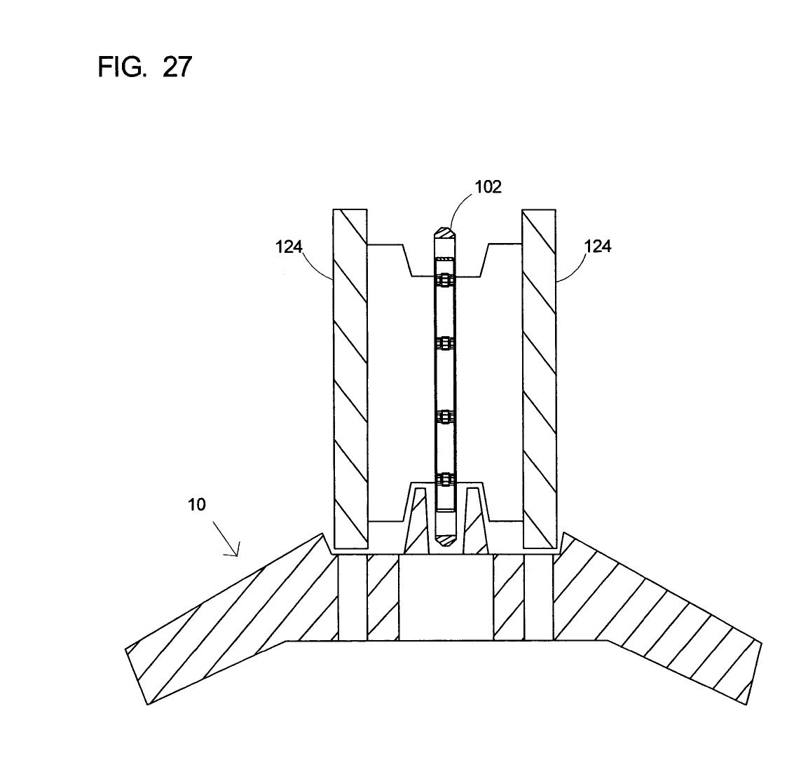

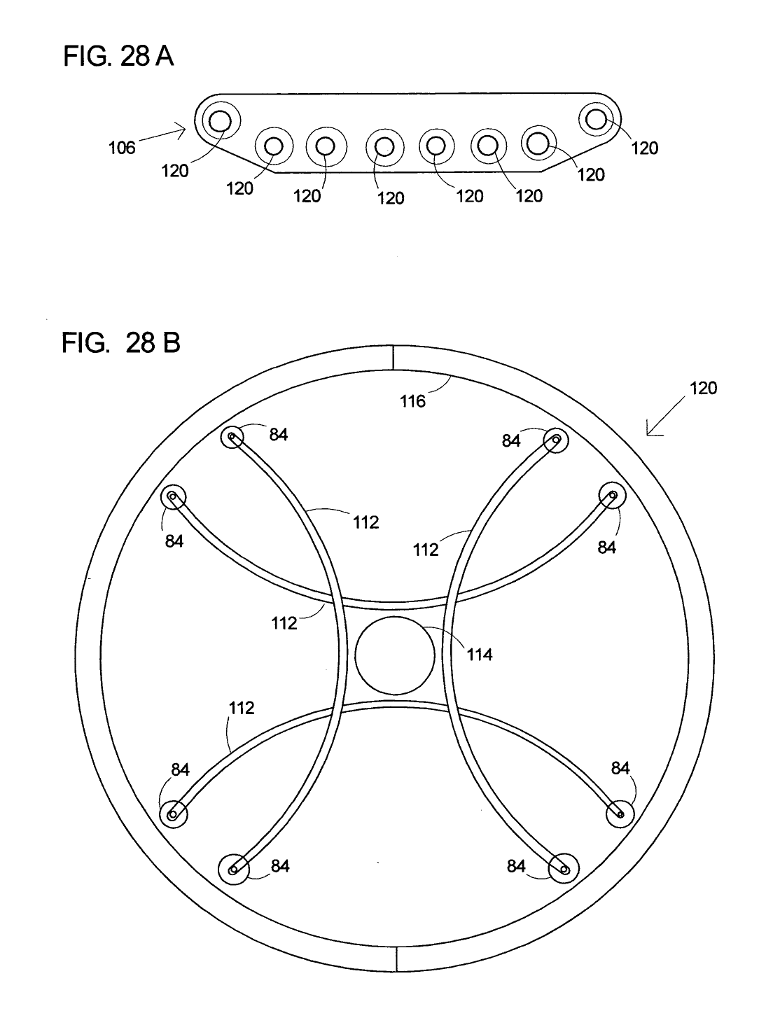

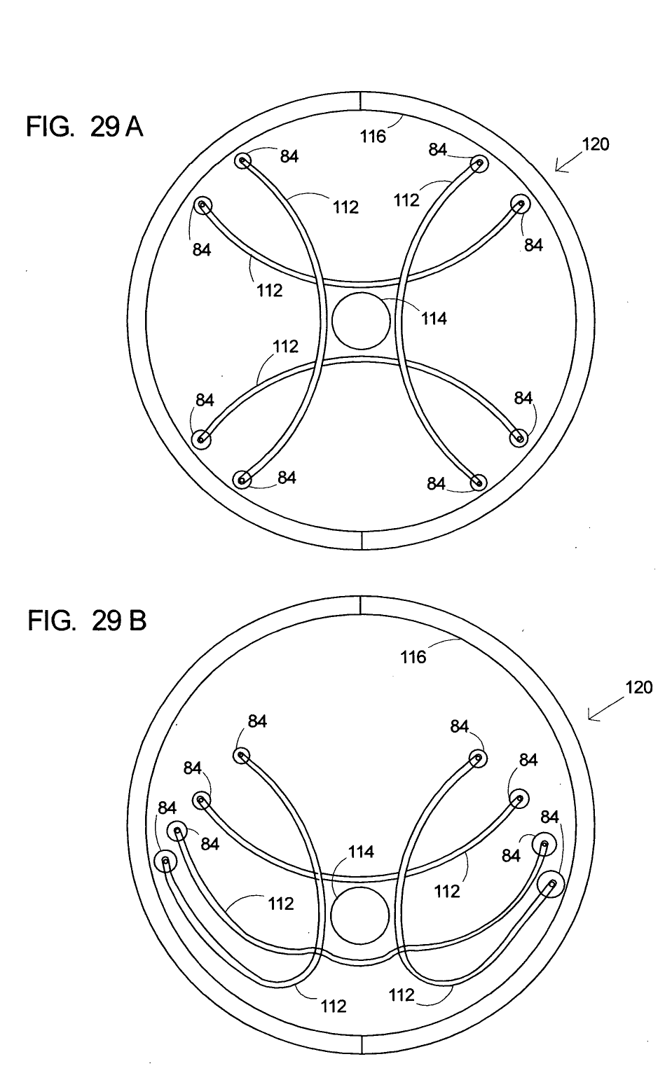

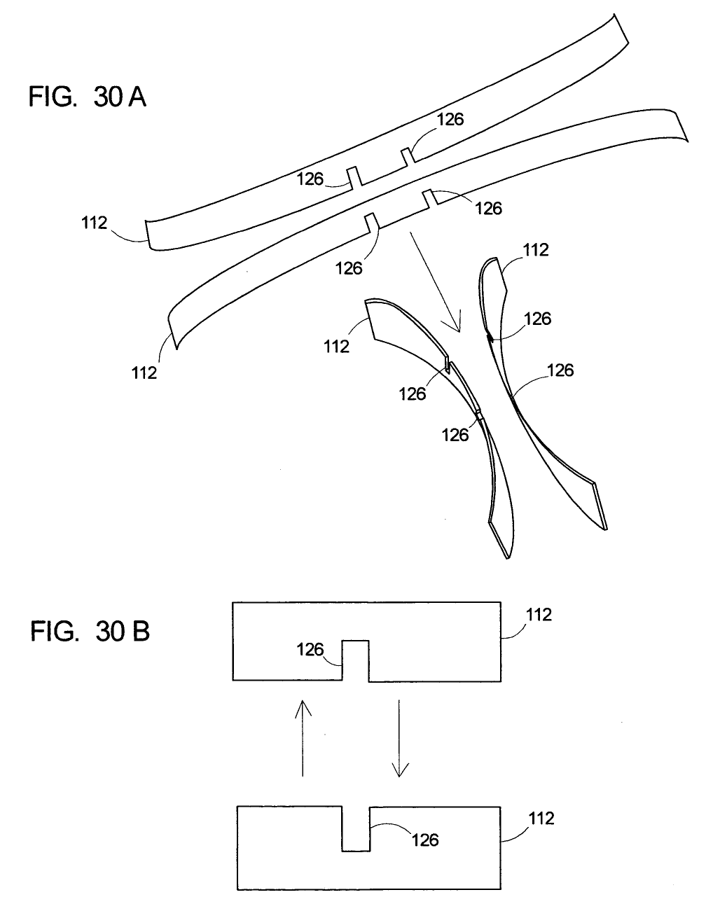

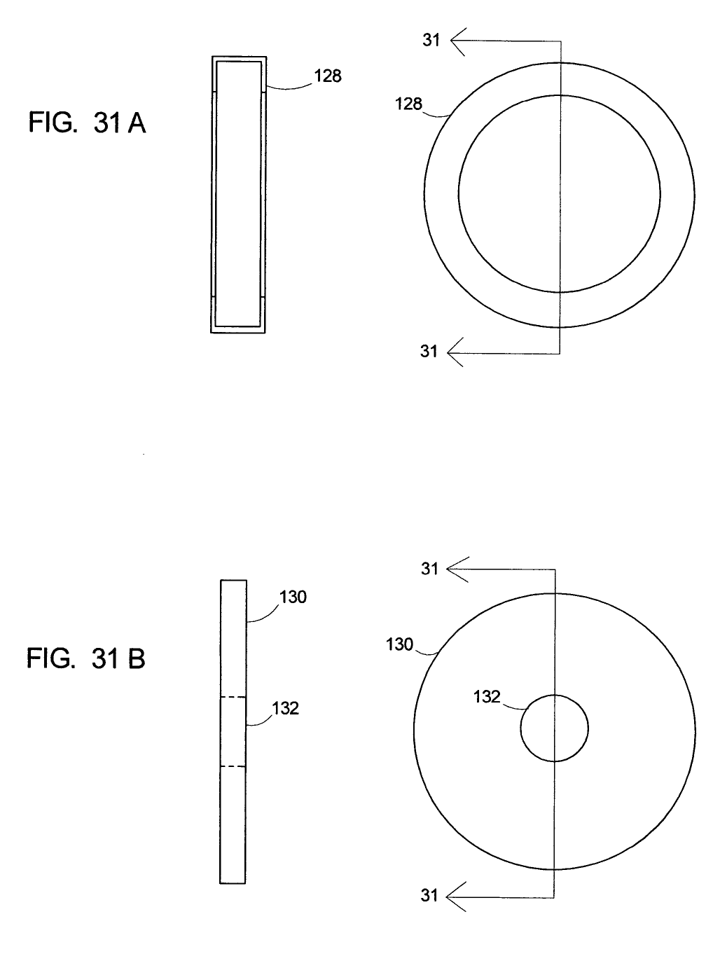

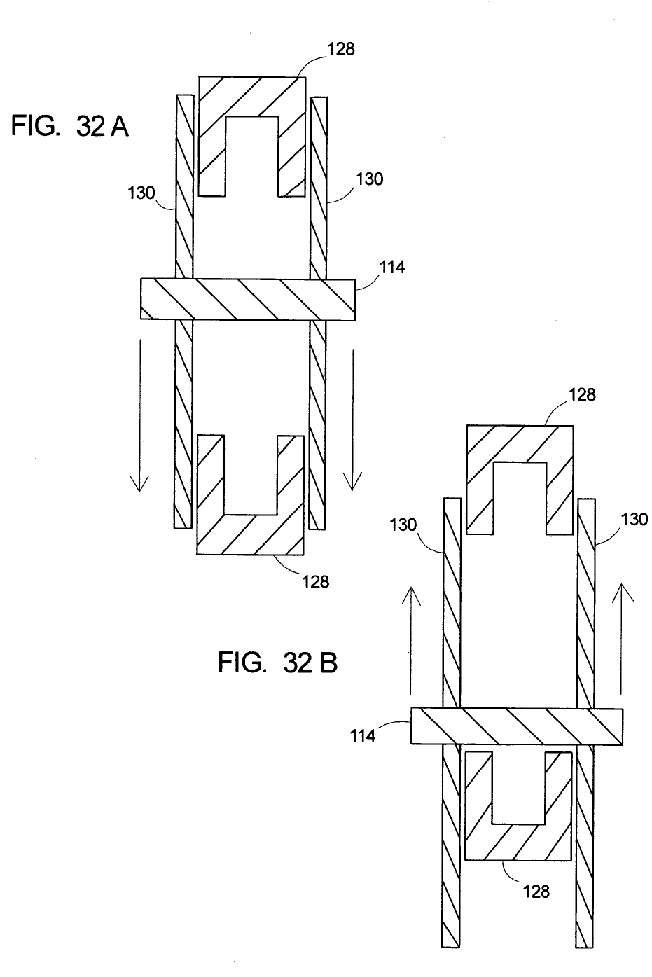

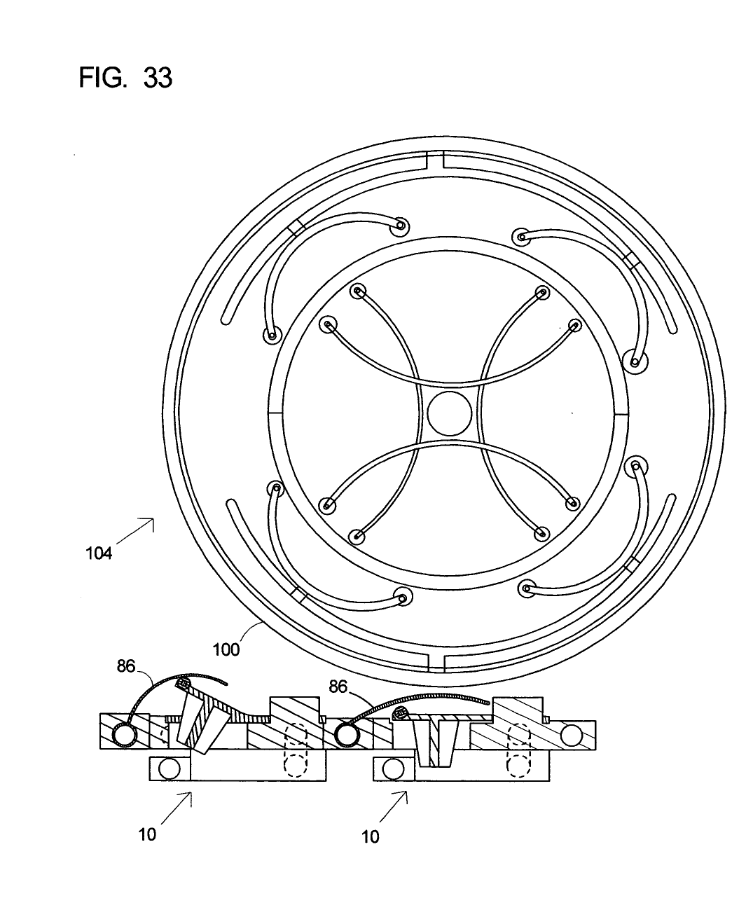

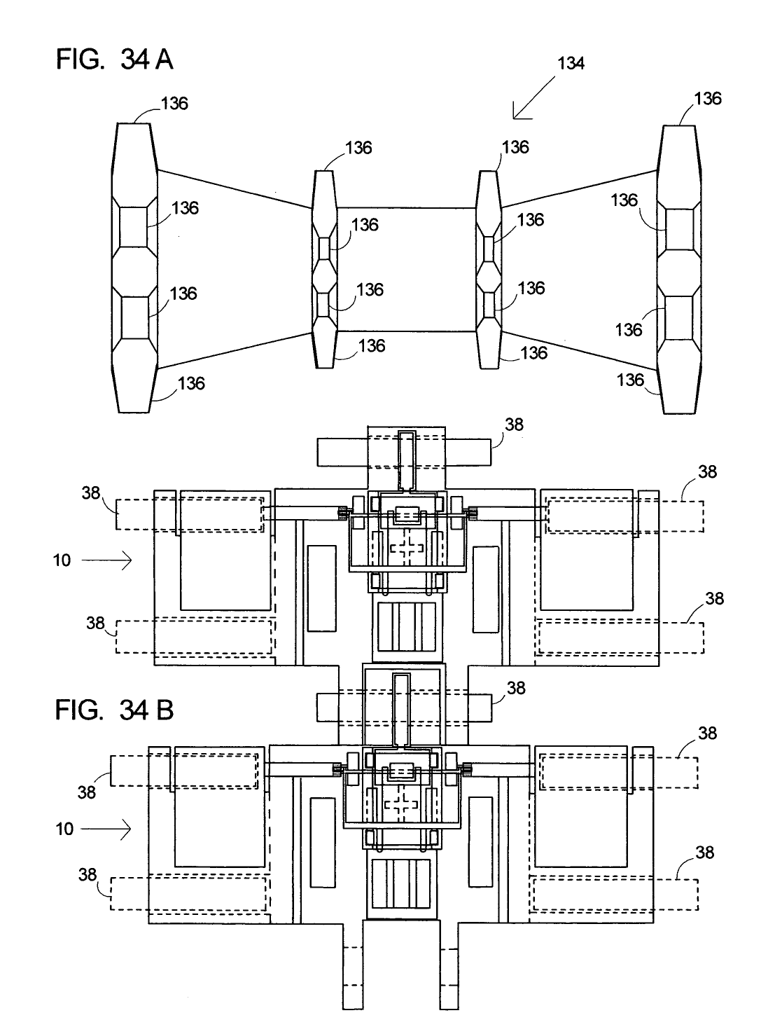

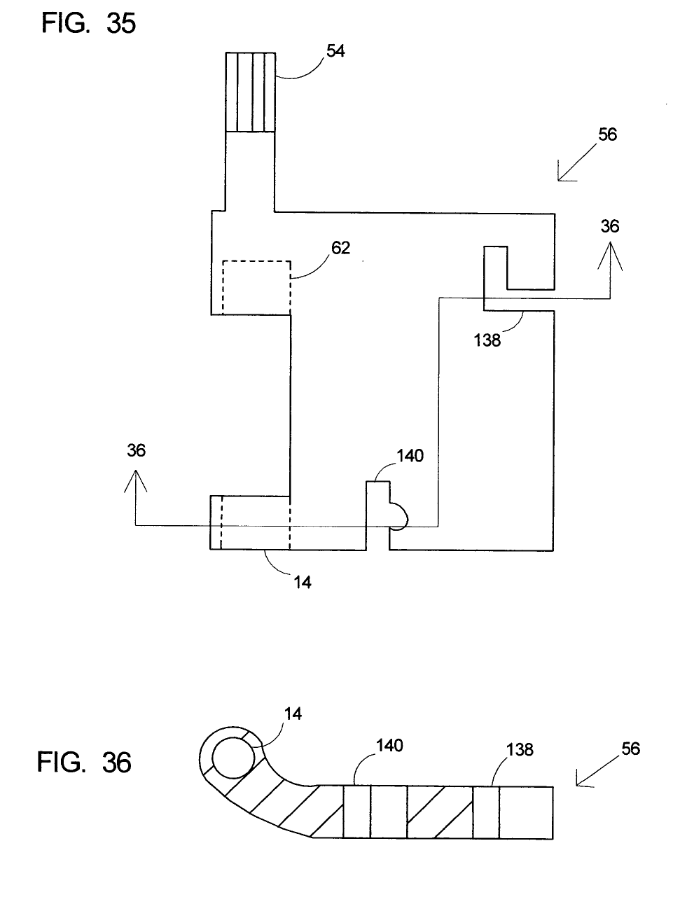

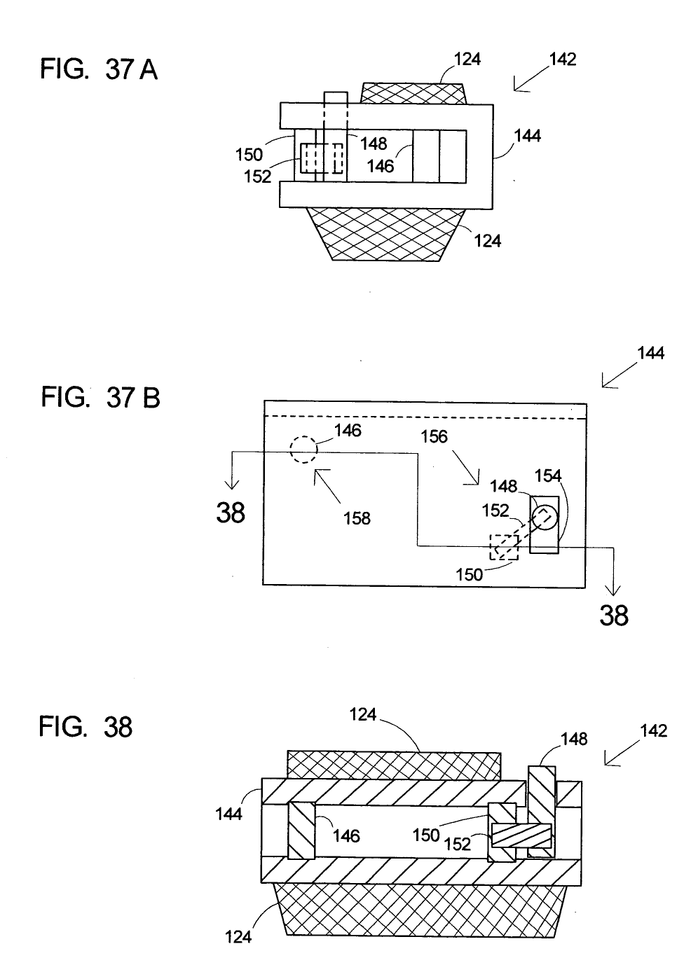

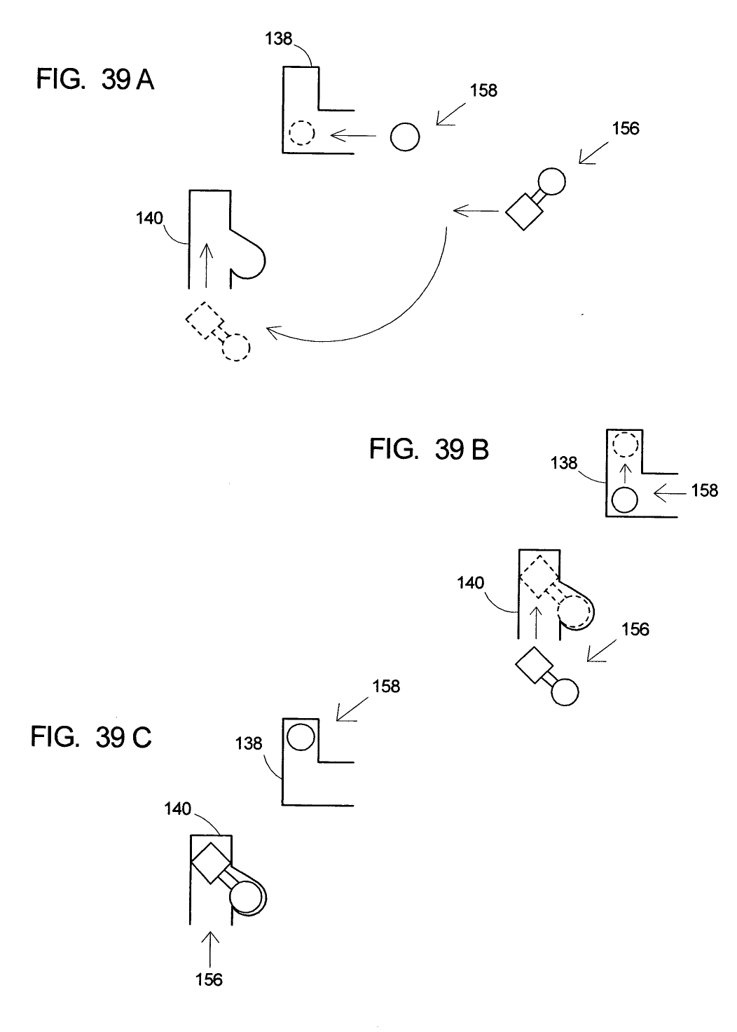

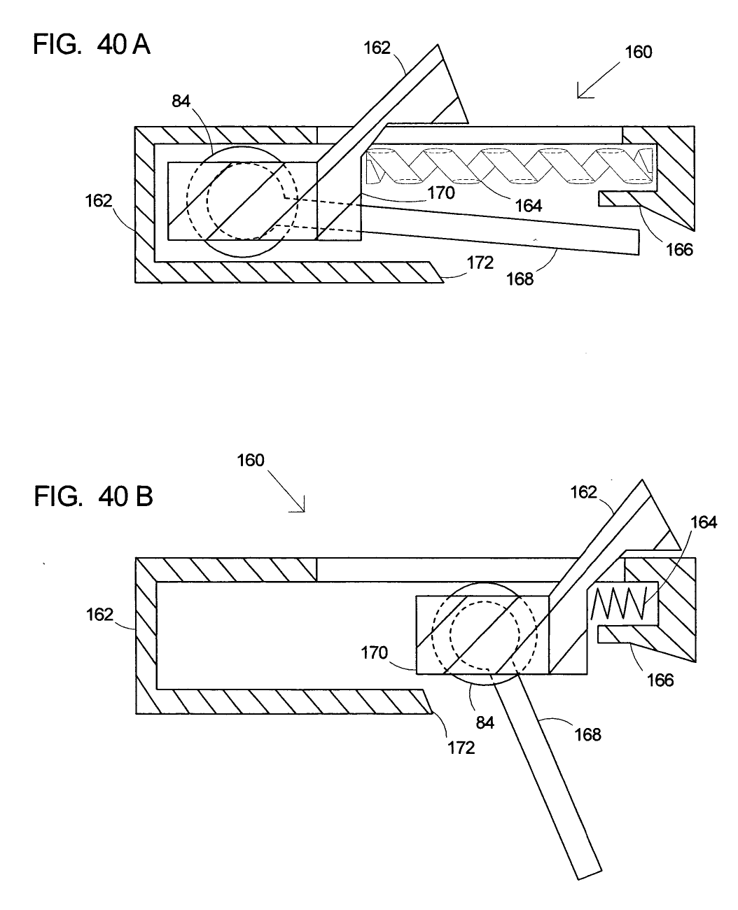

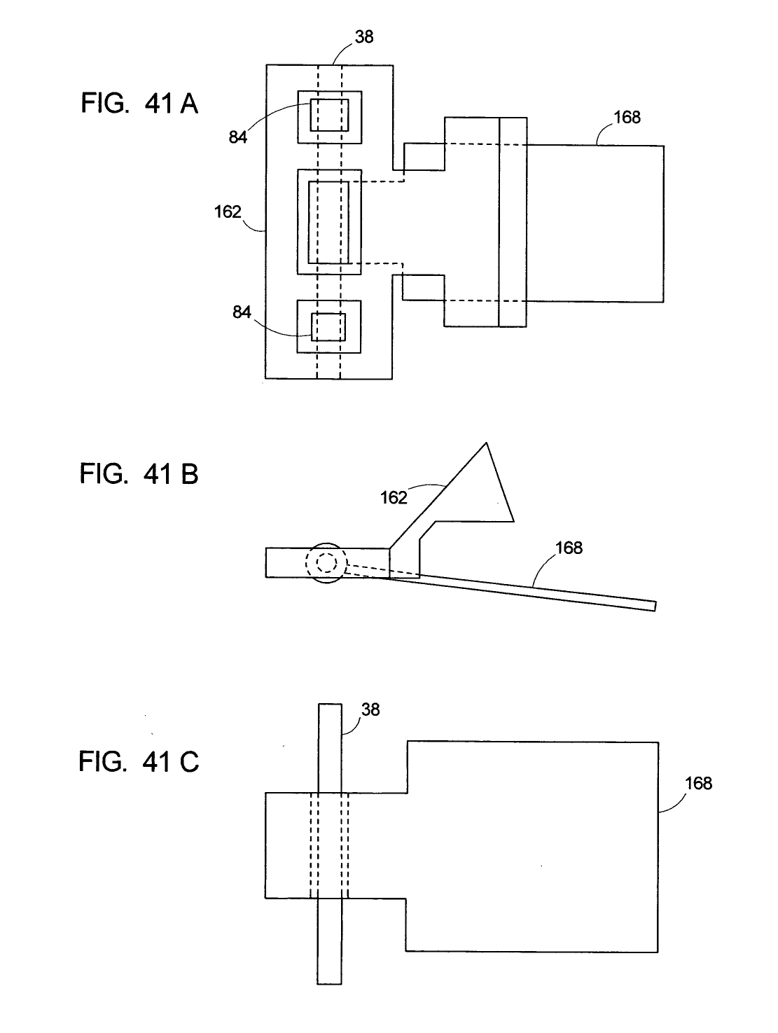

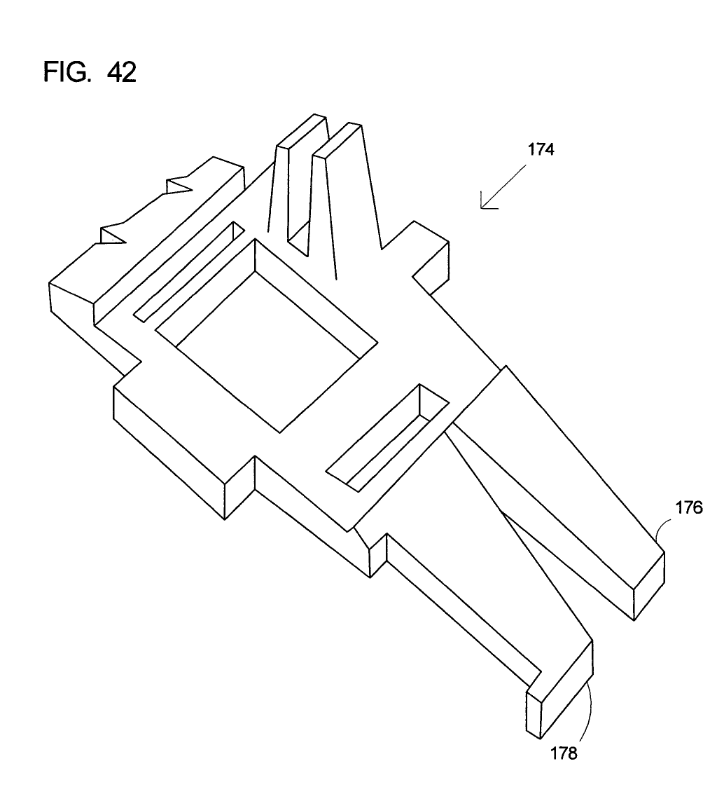

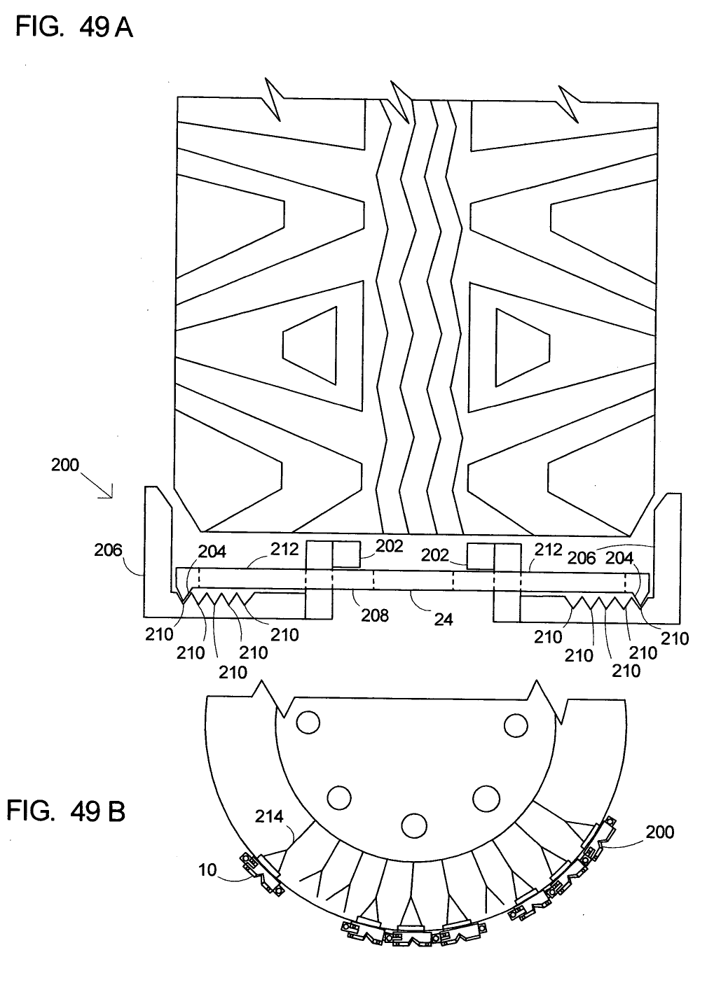

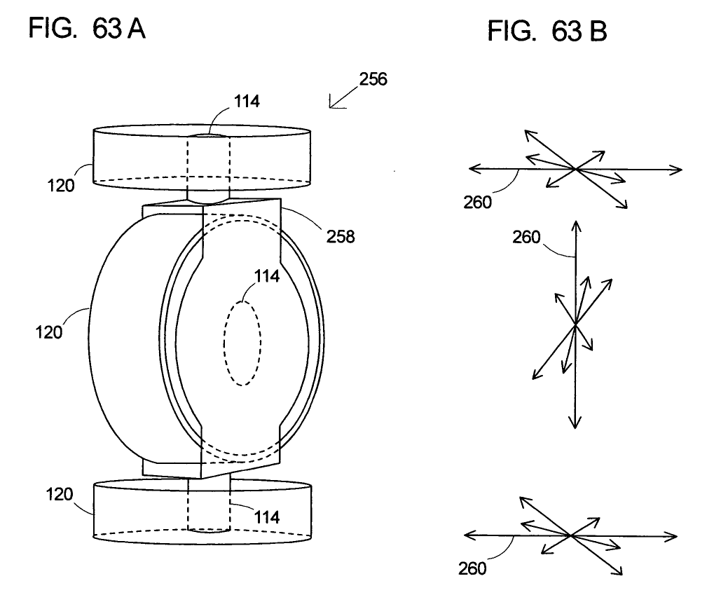

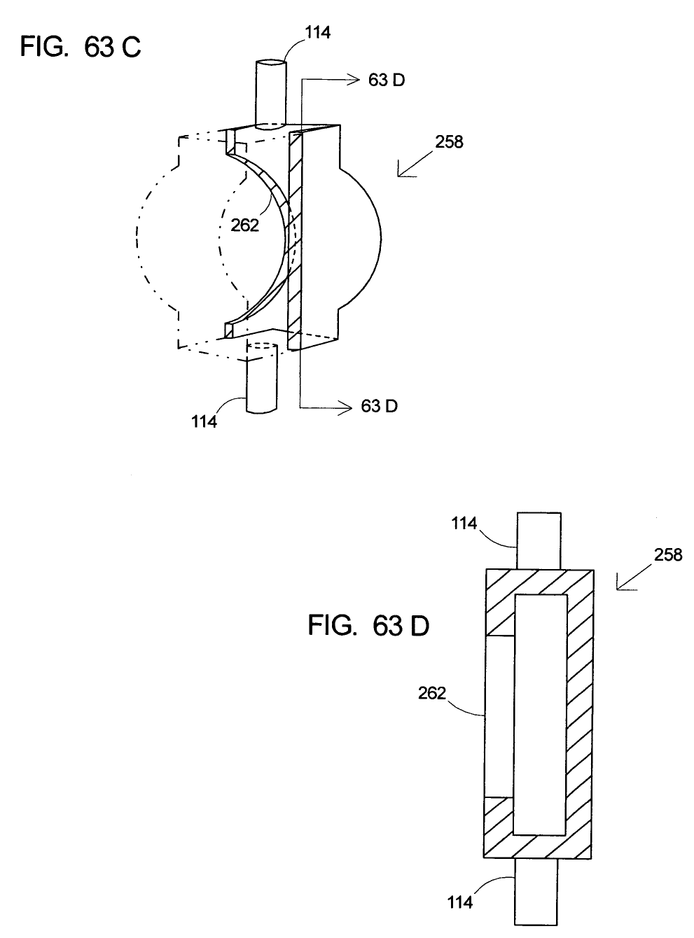

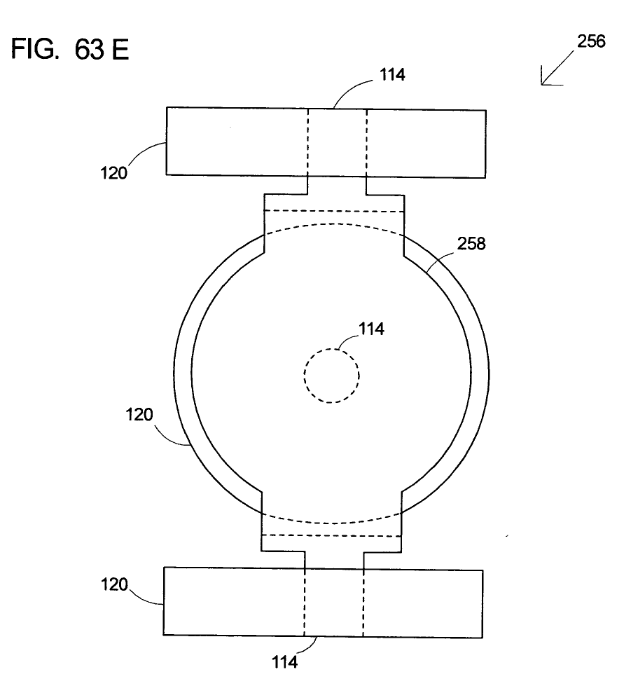

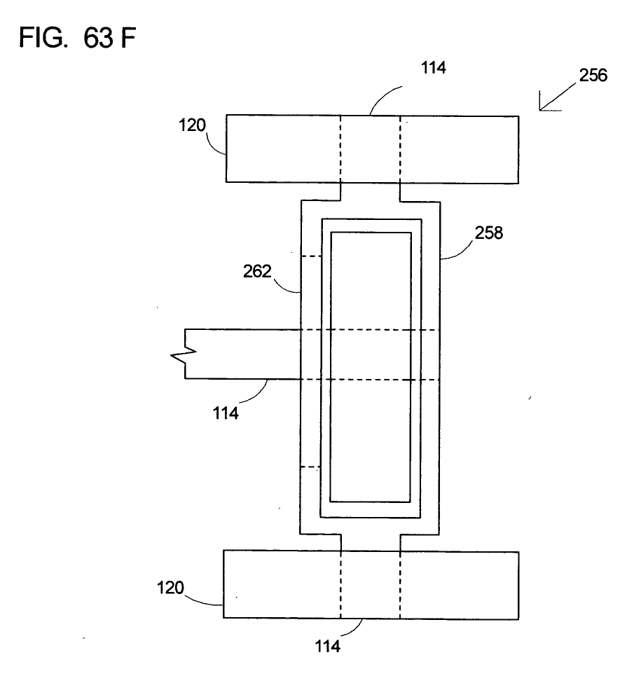

An endless chainlink 10 as in FIG. 1 are interconnected from end to end such as FIG. 34B at FIG. 1 number 18 rear and 16 front connections to create a track system of an endless or desired length of an undercarriage system FIG. 28A shows an undercarriage system with interconnecting links in a longtitude direction an undercarriage assembly having a drive sprocket with a means to rotate inturn driving interconnected chain links in a longtitude directions by gripping sprocket slots as in FIG. 1 number 20 or optional side links as in FIG. 34A and B so as the track system moves it travels over or under a multitude of roller wheels FIG. 28A numbers 120 that guide and stretch the tracks into a snug fit and with the aid of link guides 66 FIG. 1 number 36 these run through a cavity of roller wheels FIG. 27 preventing tracks from latteral motion in combination with roller wheel link shoulder FIG. 3 number 34 optional design is to make the link guides 66 detachable or incorporate a spacer block to make chainlinks adaptable to rubber wheel assemblies as in FIG. 49B the undercarriage system has internal wheel suspension for the multitude of roller wheels FIG. 28A and B which have a mutitude of leaf springs number 112 around a roller wheel axle number 114 with bearing end tips number 84 that create a quieter and smoother flexing transition as in flexing illustration of internal wheel suspension FIG. 29A which is in a unstressed status with FIG. 29B shows stressed status FIG. 30A is exploded view of resilisent leaf springs and FIG. 30B showing the clip on assembly of leaf springs FIG. 32A unstressed and 32B stressed is the front view of the internal roller wheel suspension case a working illustration a through axle case type number 130 are gude plates that prevent laterral motion or an option of through one side as in FIG. 63F so as the track continues it's travel in a longtitude direction and pivots around the front roller wheel which changes the track direction down and towards the rear soon after the track links reaches ground level it contacts the roller wheel deppressor shown in FIG. 27 front view and side view FIG. 33 and FIG. 23B showing the assembly FIG. 24A and B shows deppressor ring 100 which moves accordingly the resilient leaf springs number 110 relay spring and inturn moves 118 tensioner spring from unstressed position and 84 bearing end tips that provide quieter and smoother flexing transition this assembly is positioned around the internal wheel suspension assembly as in FIG. 23B when a greater force from terrain features is encountered FIG. 25 shows result of collapsed and stressed deppressor of resilient leaf springs which automatically goes back to it's primary position as soon as terrain force dissapates FIG. 21A shows the working illustration of cam lock assemby when deppressor ring 100 depresses 86 the reverse leaf spring the reverse leaf spring allows roller wheels to travel forward or reverse as mounted on a link chasis FIG. 22B number 86 is unstressed or retracted position and FIG. 22C is stressed or deppressed position which inturn depresses the penetrator FIG. 16 into terrain for traction the sequence operation FIG. 21A shows the deppressor ring 100 depressed the reverse leaf spring 86 passed 94 slide spreader cam that is spread by the downward travel of 86 below the camlocks 92 of the resilient camlock sleeve chasis FIG. 20 number 84 reveals the optional bearings that provides a quieter and smoother flex passage and with 86 the revese spring at the bottom of the cam sleeve 92 are the cam locks that keep 86 the reverse spring from going back up until a greater force is exerted FIG. 1 is a chainlink 10 chasis of a hard resilient material be it metal or plastic or composites or the combination thereof FIG. 3 number 32 showing the chainlink 10 with outward angle 68 downward on the sides the more the degree angle 68 downward the stiffer the resistence and is subject according to vehicle specifications FIG. 1 shows a multitude of slots for quick attachment of cased assemblies 28 a flap assembly slot 22 a flap gearing slot 20 optional sprocket slot 24 centered penetrator slot the penetrator assembly and flap assembly penetrator work together simeoustaneously as in exploded views FIG. 6 and FIG. 16 and 17 with top view 15 therefor FIG. 22B penetrator assembly and FIG. 8A are both retracted or unstressed status so together the penetrator FIG. 22C is deppressed at the same time FIG. 9A flaps are exstended the sequence begins with the roller wheel deppressor pushing down on the resilient penetrator assembly which is connected to flaps by FIG. 12A number 64 as penetrator conection which moves 40 flap linkage this pivots on the penetrator attachment pivot FIG. 12B number 66 the flap linkage is a set of two as in FIG. 12B connected by the pivot 66 this system work two flap assemblies FIG. 6 and 7 one on each side of the chainlink 10 FIG. 13A number, 72 connects the flap limk to the buffer leaf spring as in FIG. 8A number 42 which allows the flaps to retract even if center penetrator is deppressed the buffer leaf spring dissapates possible counteracting forces number 74 FIG. 13A connects to 76 FIG. 14A slide gear FIG. 8A number 44 which moves in a longtitude direction to rotate 54 lower flap gear which turns 48 transmission FIG. 11B shows the transmission connecting lower flap gear 54 and upper flap gear 60 wth gear 52 that exstends or swings out both upper and lower flaps as in FIG. 9A both flaps are manipulated through the sun gear transmission FIG. 11A this process allows the upper and lower flaps to retract and exstend at the same time FIG. 4 shows flaps exstended the resilient flap penetrators 58 are designed as one piece unit having a hollow torsion drive shaft with geared ends this allows the shafts to flex with the chainlink 10 ends other options is to incorporate mini universal joints the flap penetrators 58 automatically exstend on soft or liqufied terrains and automatically retracts as harder or stiffer terrain is encountered so as the center penetrator remains extended until solid surfaces such as asphalt and rocks are encountered therefor it automatically retracts acordingly as terrain dictates so as the other penetrators FIG. 3 number 32 on the same principals of terrian dictations the downward angle 68 of the chainlink 10 ends becomes stressed or levels out with the weight of vehicle and stiffnes of terrains going up and down as terrain dictates automatically so now with the track links following on course towards the rear depending on terrains the multiple penetrators are retracted or depressed and if depressed the links encounter a roller wheel exspander at the rear of the undercarriage system as in FIG. 26A number 102 which exspands as in FIG. 21B number 94 is spread by 102 roller wheel inturns moves 92 camlocks to the side allowing 86 the reverse leaf spring free to come back up retracting the center penetrator so as the links continues to the rear pivoting up and again pivoting around the sprocket changing course to the front in retracted position to repeat the revolution cycle again automatically and the quick release or attachment of rubber pads with various optional materials unto the lower flap assembly as in FIG. 35 having latches 138 a rotation latch and 140 a locking side latch which allows pad assembly FIG. 37A to connect by FIG. 37B latch guide pins 146 and 148 number 39A an illustrated sequence begining with number 158 slide in as 156 rotates to allighnment as FIG. 39B both 158 and 156 slide into lower flap latches 138 and 140 as in FIG. 39C snapped and locked now to attach the chainlink 10 track onto a rubber wheel assembly either individually or a multitude set is dependent on rubber wheel system design as in FIG. 49A and B which is showing links interconnected togther around a wheel assembly and secured in place by strap chains around a wheel because of the rubber wheel design the center penetrator is to be replaced by a centrifical penetrator FIG. 40A unstressed or retracted position and 40B in deppressed or exstended position operation sequence begins with the rubber wheel contacting slider guide in FIG. 40A number 162 as it slides against the spring retractor number 164 it gliides on bearing 84 as the spring collapses number 168 penetrator blade tip glides by under a kicker exstender 166 which exstend the penetrator blade further as the penetrator assembly goes rearward FIG. 40B shows the end result now the penetrator is dependent on terrain hardness which can retract the penetrator by aiding the spring retractor to push the penetrator assembly manipulating 168 the penetrator blade to glide over 172 the kicker retractor collapsing the penetrator blade into the penetrator case 162 until a soft terrain is encountered the centrifical penetrator retracts and exstends automatically as the terrain dictates

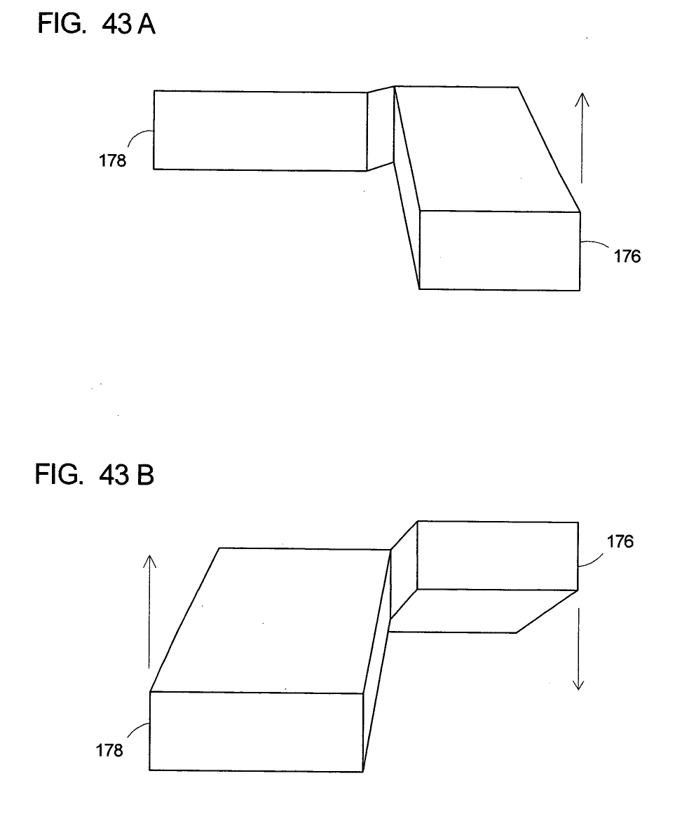

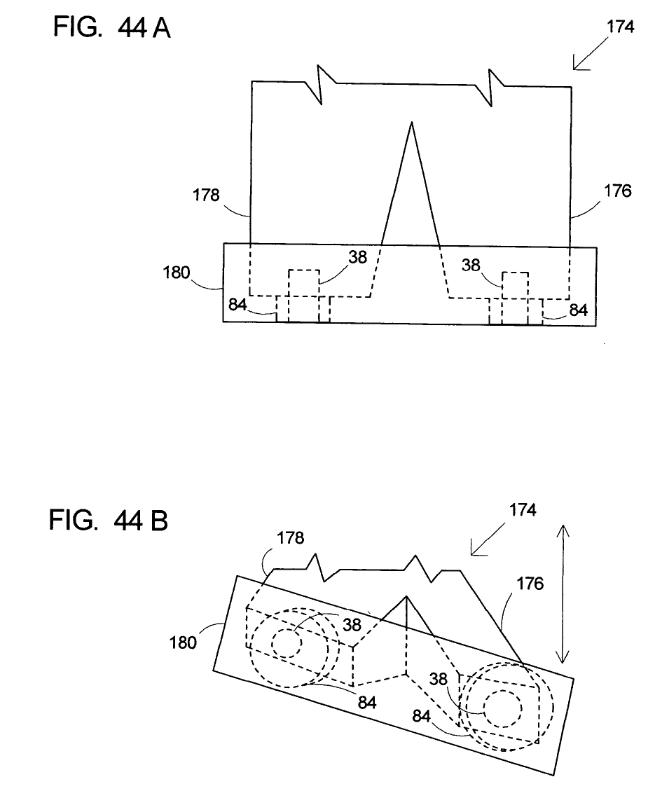

Aternate embodiment FIG. 42 a resilient chasis with split side ends of a fork type number 176 and 178 this design gives an added articulation of a lontitude ability as in illustration of FIG. 43A and B showing the ability of forming better to the contours of terrain and FIG. 44A shows the top view of forks equipped with universal joint case 180 and 84 bearings which gives the back and front to still work independently of each other FIG. 44B shows the fork link chasis negotiating an uphill slope

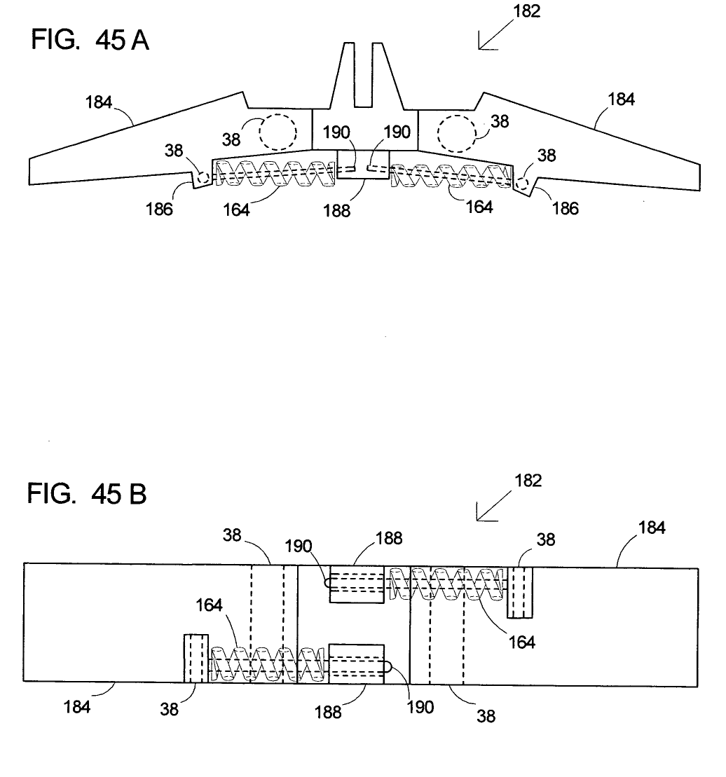

Alternate embodiment FIG. 45A a resilient chasis with swing free sides pivoting at 38 the resiliency is incorporated by long springs 164 and guided into position by 190 guide shafts which is anchored at the outboard side 186 of the chasis and the guide shafts are in turn guided by 188 stationary block shaft slots

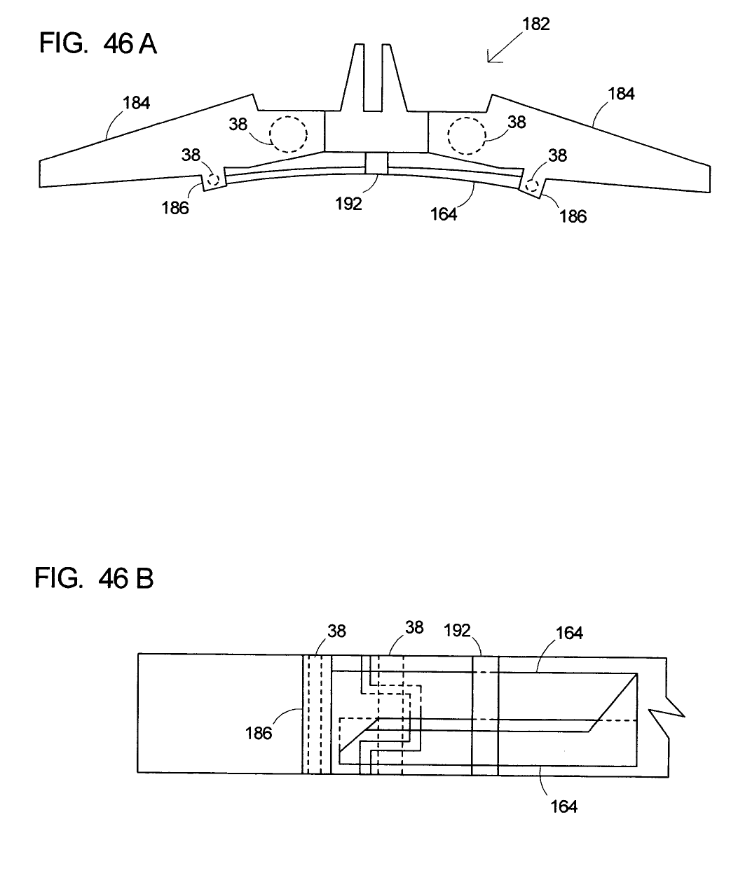

Alternate embodiment FIG. 46A uses the same principals as FIG. 45A instead of the coil springs leaf springs number 164 is opted for

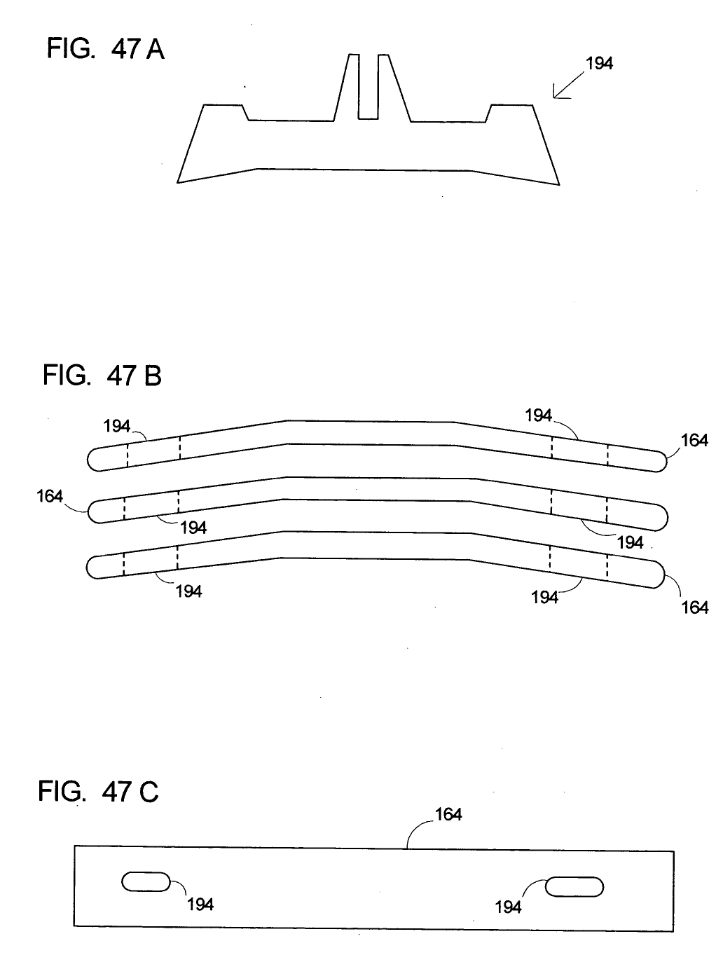

Alternate embodiment FIG. 47A a chasis where multiple leafs FIG. 47B is attached onto and FIG. 47C slack slots 194 combine and maintains a secured minimum movement at the ends of the leaf springs

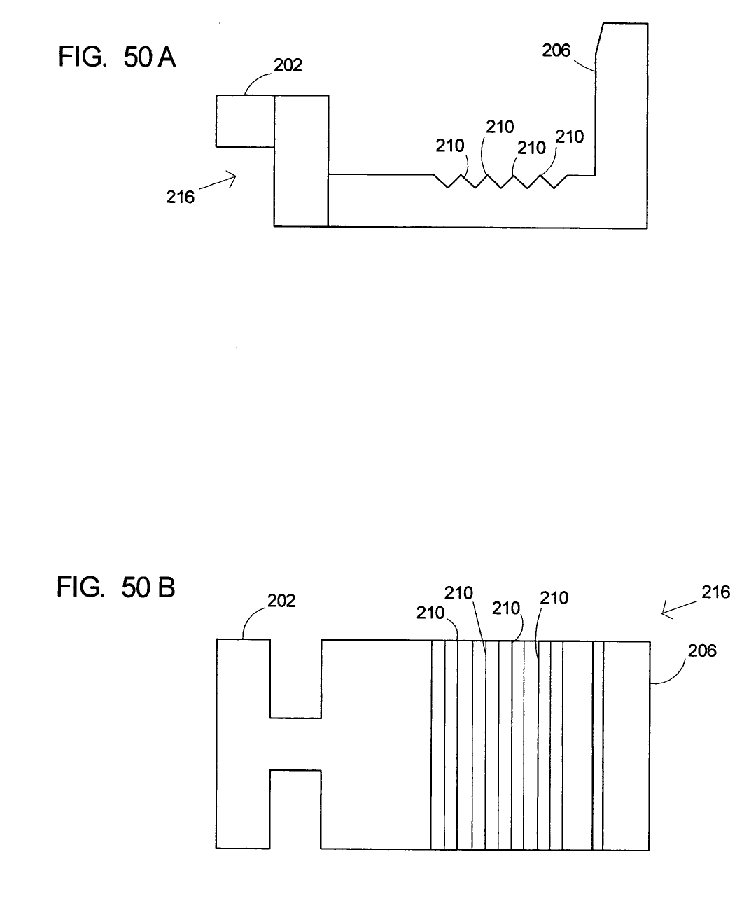

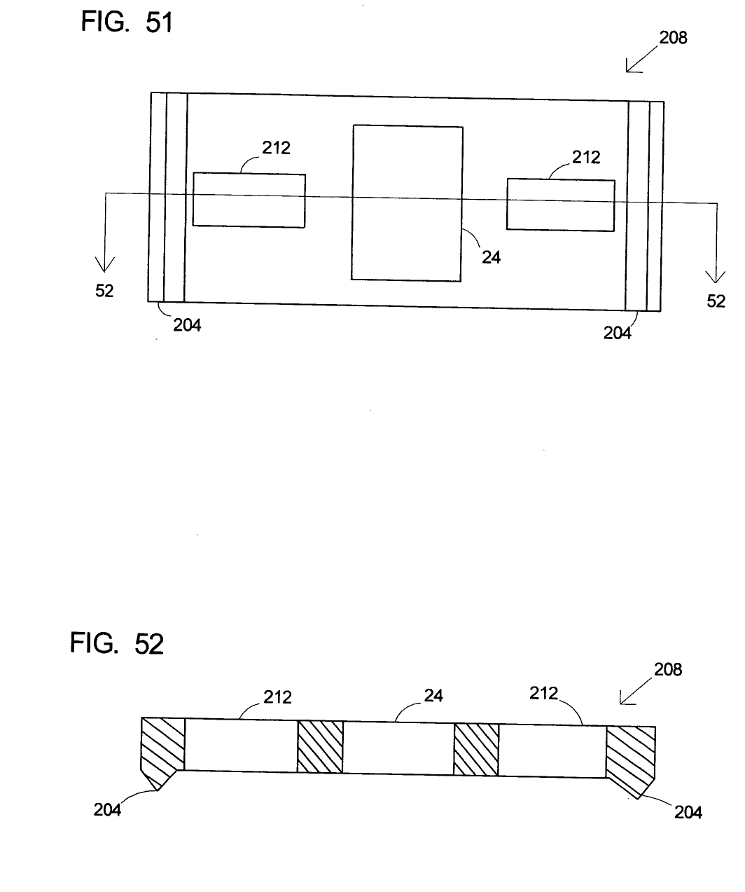

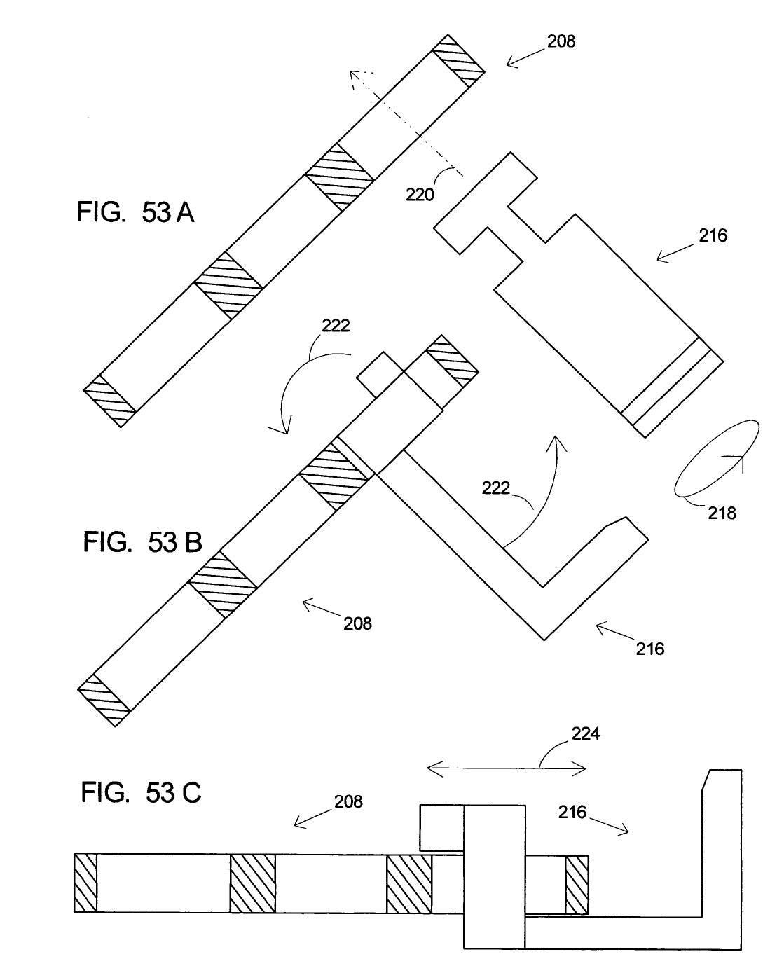

Alternate embodiment FIG. 49A because of the multitude of various widths of rubber wheeled assemblies it is considerable to design an adjustable chainlink 10 number 200 a chasis 208 having 24 penetrator slots for centrifical pnetrator FIG. 40A and 212 slider slots with gravity locks keys 204 are long keys at the ends of the chasis that is set into place upon FIG. 50A brace adjuster which have multiple long grooves that recieve 204 keys and locks into desired place preventing unwanted movement FIG. 53A is the begining sequence of attachment of brace adjuster 216 unto the chasis 208 following 220 path through chasis slider slot then after in place is rotated clockwise number 218 and in place in FIG. 53B then following the path of 222 bringing the brace adjuster to the level plane of the chasis as in FIG. 53C and adjusted accordingly number 224

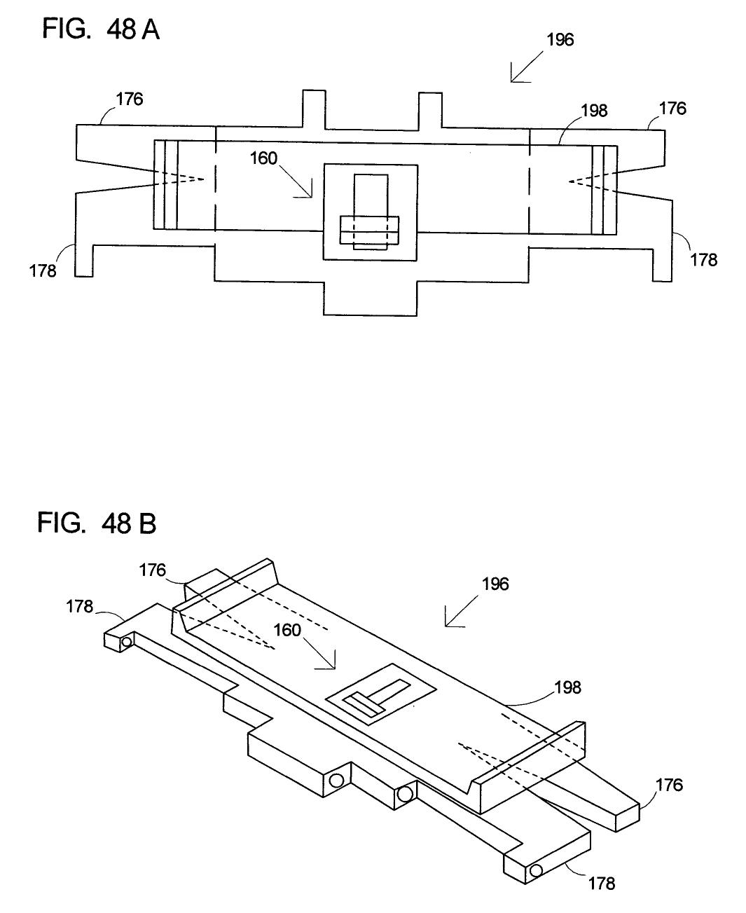

Alternate embodiment FIG. 48A and B of a resilient chasis with a top plate 198 for extra heavy vehicles or utilizing latch system FIG. 39 in combination with FIG. 49A for rubber wheel adjustability on top plates

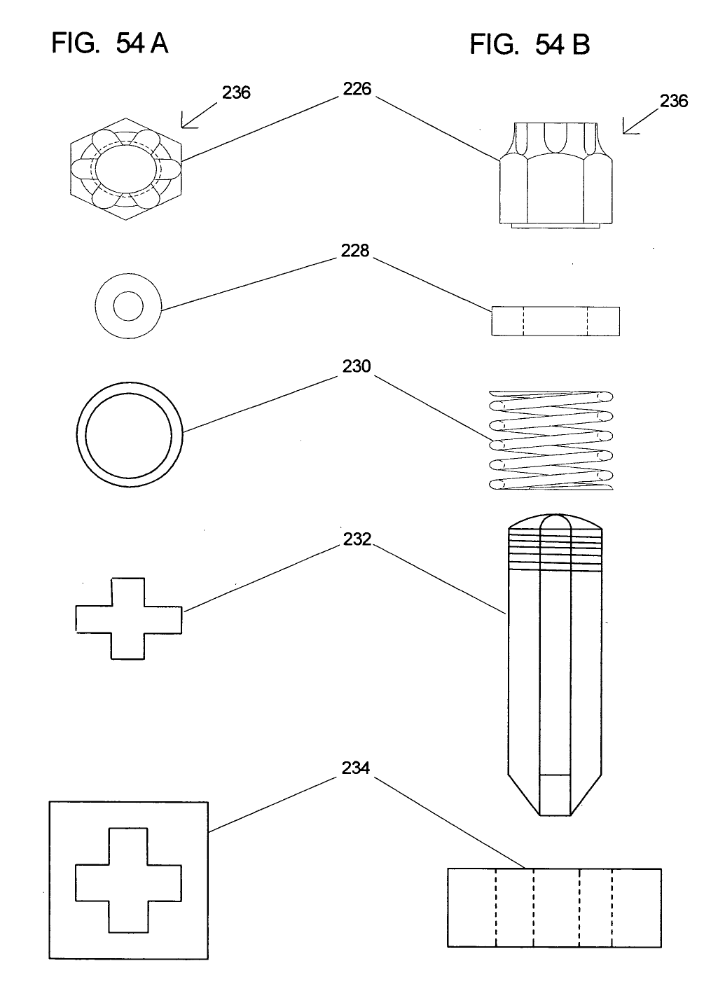

Alternate embodiment FIG. 54A a top view and FIG. 54B is side view of longer penetrator design when a deeper penetration is required 234 assembly case sleeve that is attached unto the chasis penetrator slot FIG. 1 number 24 the penetrator shaft 54A number 188 is able to manuver up or down through the 234 sleeve and 232 is topped with threads for the 226 castle nut that secures 230 retractor spring and 228 spring washer in place with cotter pin in nut the tension is on retracted side

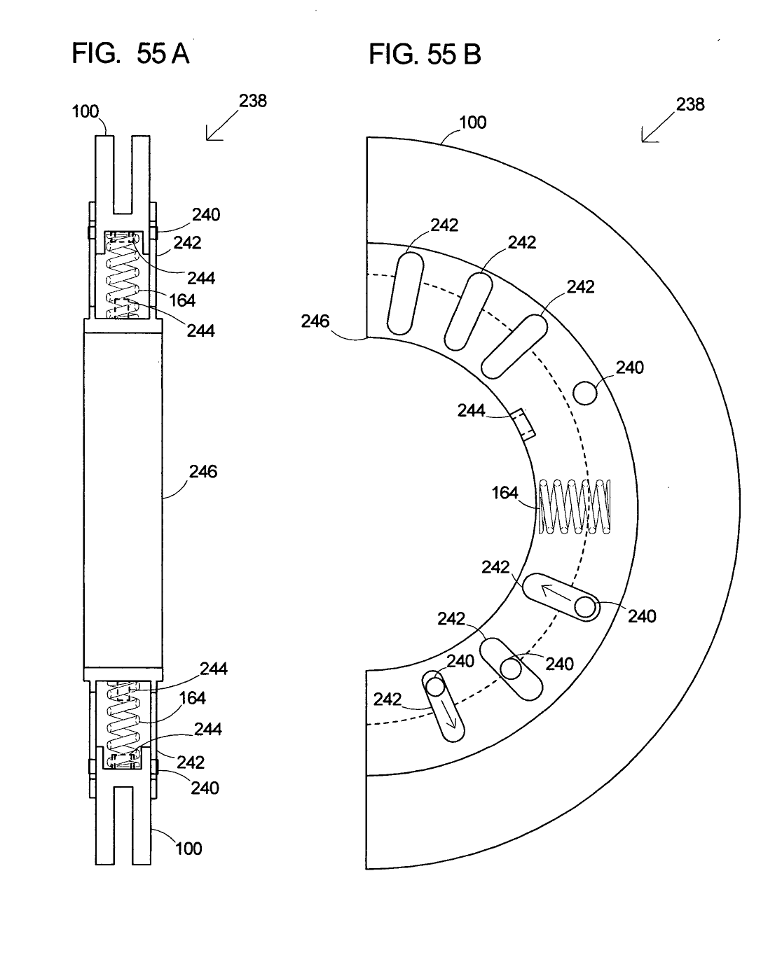

Alternate embodiment FIG. 55A and B of roller wheel deppressor is of a multitude coil spring loaded type 164 which gives tension to the 100 ring deppressor the up and down travel is controlled by sleeve guides 242 that allow 240 ring deppressor pin to be guided and 244 spring pins top and bottom guide to secure in place the spring as it travels up and down

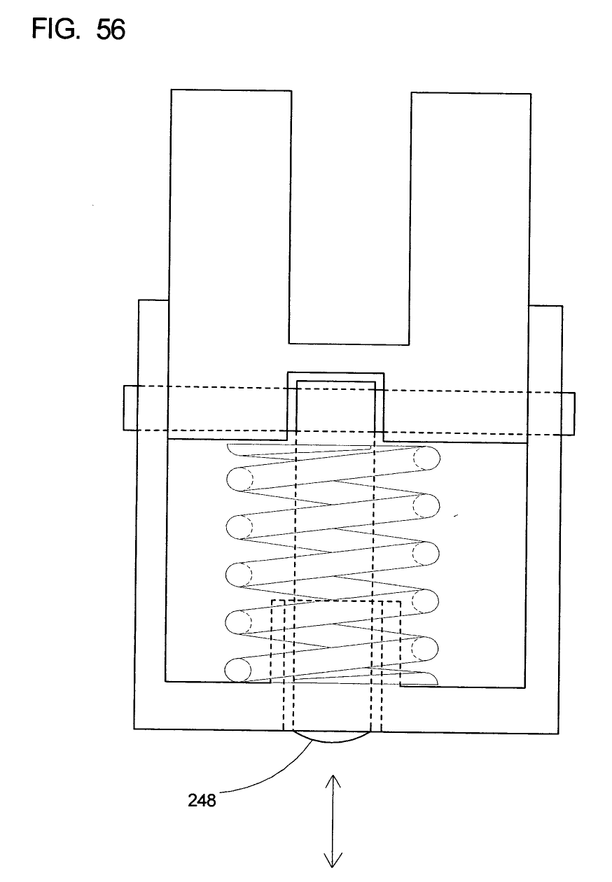

Alternate embodiment FIG. 56 of a coil spring loaded deppressor same prncipals of FIG. 55A except instead of coil spring pins a 248 shaft guide is opted for

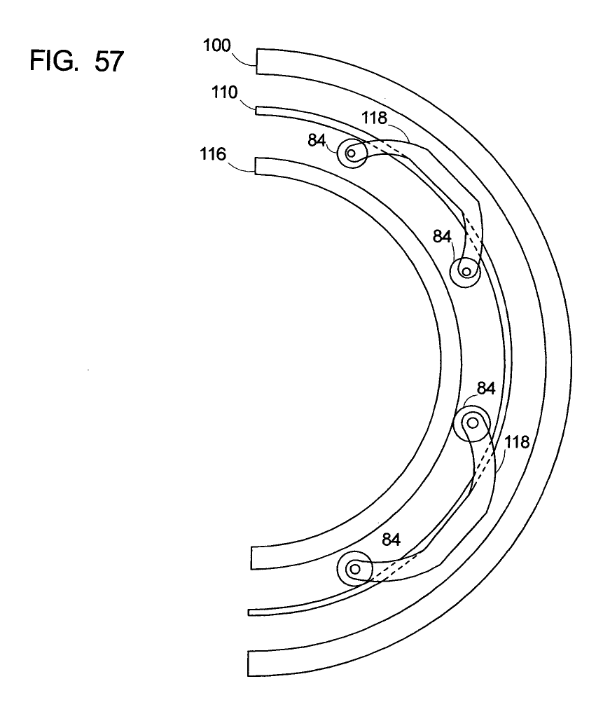

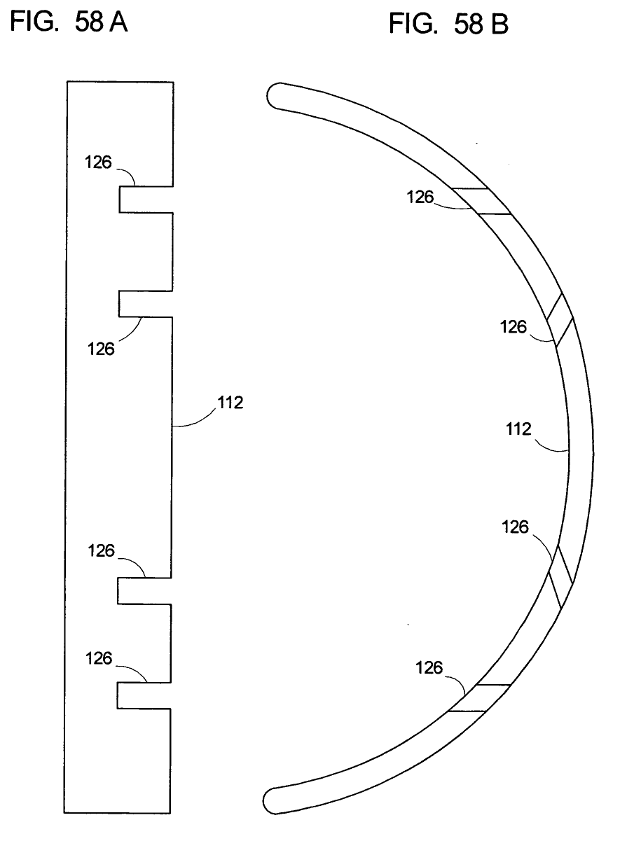

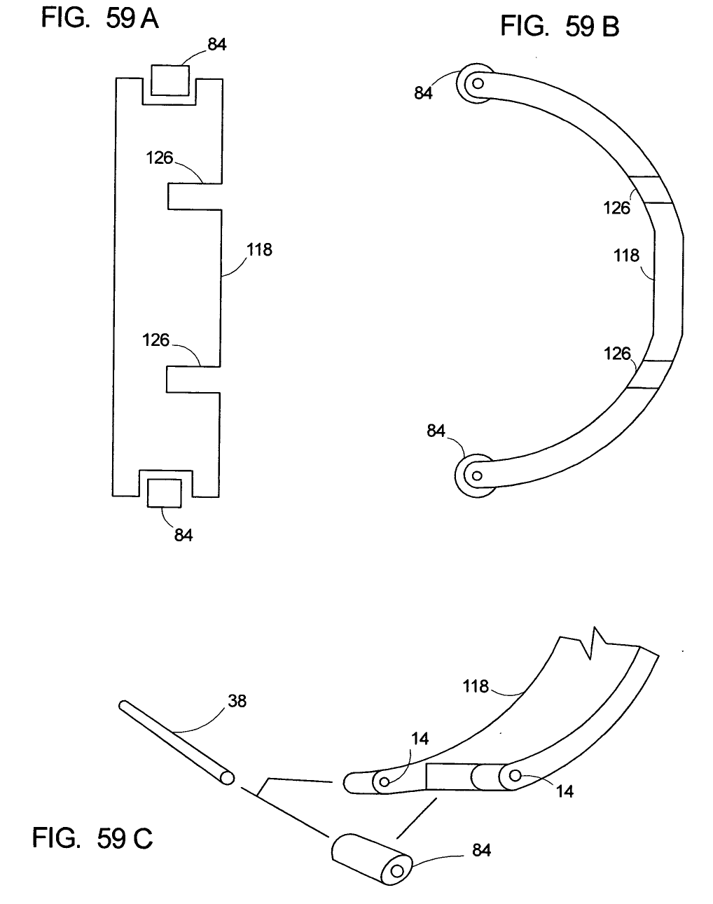

Alternate embodiment FIG. 57 leaf spring deppressor type like as FIG. 24B except instead of 108 the connection retainer the clip on design attachment FIG. 58A and B is opted for as in FIG. 30A and B number 110 spring relay and 118 leaf spring tensioner is cliped onto

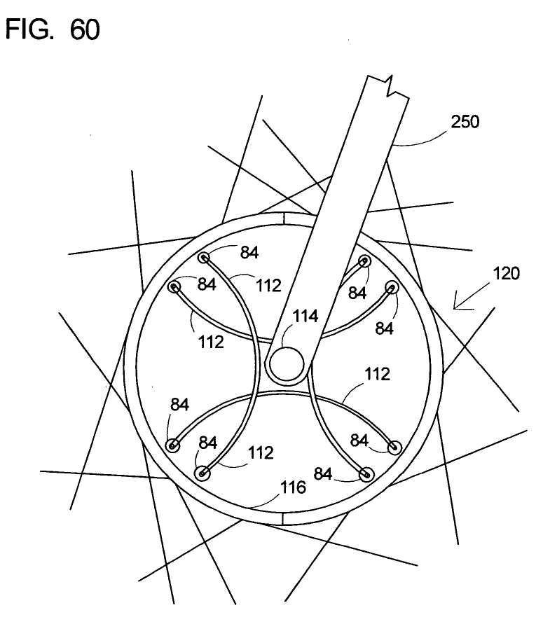

New use embodiment FIG. 60 showing use of internal wheel suspension in a motorcycle wheel or bicycle and is capable for various and all kinds of wheel assemblies for military or commercial or recreational types such as automotive and snowmobiles and all terrain vehicles and locomotive trains and robotic and space and the internal wheel suspension could stand alone or be an addittion or compliment to other suspension designs

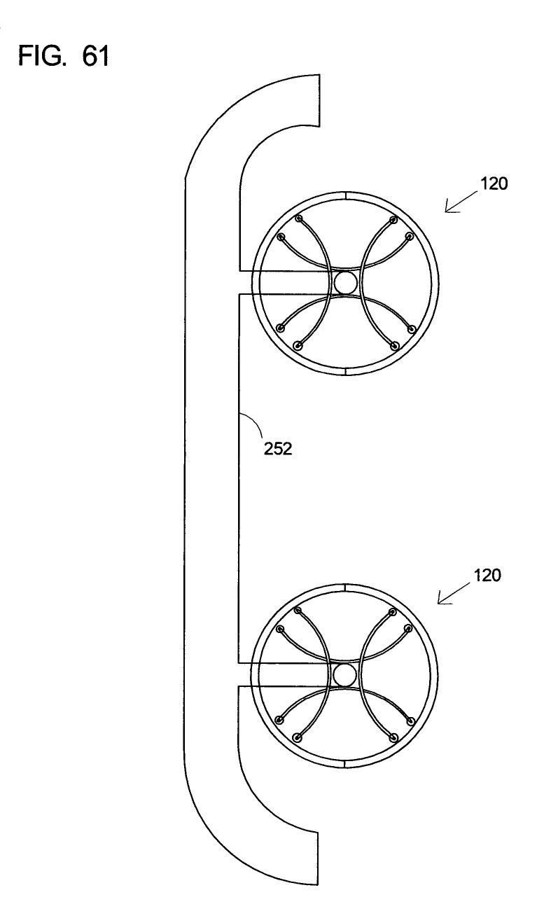

New use embodiment of internal suspension as an impact suppressor FIG. 61 on a vehicle bumper as in 252 with 120 suppressors can be used in various and all kinds of areas where impact suppression is rquired as in automotive and commercial and military such as automotive impact side panels and tractor trailer hook up frame and loading docks and boat and ship docks and road side rails and earthquake prone buildings automotive head rests as whiplash suppressors

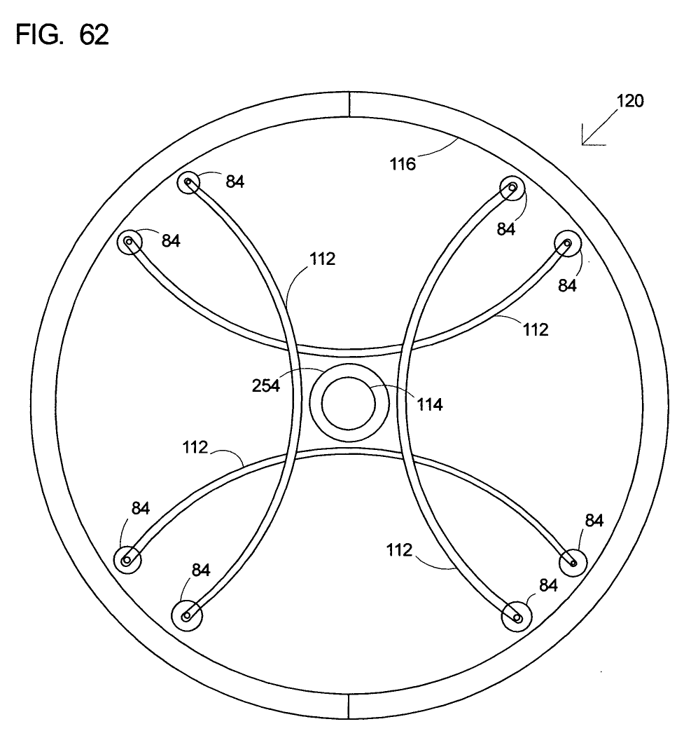

New use embodiment of internal suspension as a vibration damper FIG. 62 a hard rubber sleeve around axle 114 and rubber bearings 84 can be used in various and all kinds of areas where minimal impact and higher vibration damping is required such as automotive and commercial and machinery and military

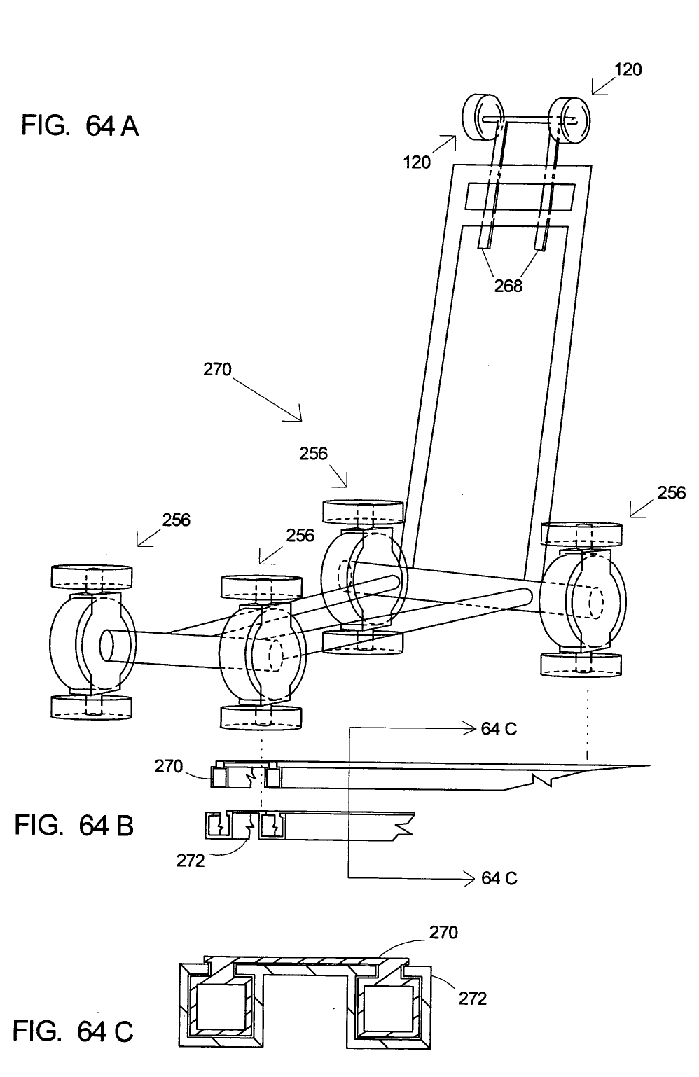

New use embodiment of internal suspension as a multiple directional impact suppressor FIG. 63A in a three dementional view FIG. 63C showing case and FIG. 63F front view with three impact suppressors as one unit 114 three axles 122 with center axle protruding to act also as a base chasis where free movement is maintain by a bigger hole in FIG. 63D number 262 can be used in all kind and various seats such as riding mower and bicycle and automotive and aircraft in single or in multiple combinations and sizes as in FIG. 64A seat frame with 120 whiplash suppressor with adjustable up and down leaf springs 268 additional suppressors 256 FIG. 64B and C is view of slide racks 270 goes into 272 which allows 270 being secured to chair to move back and front for adjustment of seat within 272 as 272 is secured to a base

Since other modifications and changes varied to fit particular operating requirements and environments will be apparent to those skilled in the-art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. a multiple terrain and various types of vehicle undercarriage system with
substantially improved traction that operate automatically in transition from terrain to terrain including amphibiously and that can be adaptable to attachment predetermined unto rubber wheel assemblies comprising:
“(a)” means for multiple traction penetrators comprising:
a resilient chasis with side ends angled downward as traction penetrators
an enlongated traction penetrator attached unto said chasis
traction flap penetrators attached unto said chasis single or multiple or the combination thereof attachments is optional according to vehicle specifications
whereby multiple penetrators substantially improve traction in various kinds of terrains
and can be adaptable to various types of vehicles according to there specifications
“(b)” means for automation comprising:
resilient technology principals in combination with vehicle weight and terrain temperment
said technology with undercarriage parts of resilient metal or resilient plastic or resilient composites or the combination thereof
said weight being a constant gravity depresses said parts into said terrain when in a soft or liquid temperment
When said terrain is of a hard or solid temperment the terrain resistance pushes said parts to flex against said weight acomplishing automatic retraction of said parts
whereby the said terrain in combination of said technology provides said automation of depressing and retracting in transition as manipulated by terrains
“(c)” means to adapt attachment of chainlinks unto existing rubber wheel assemblies
single or multiple wheel designs comprising:
chainlinks equipped with centrifical traction penetrators attached to said links
said links interconnected around said wheels and closed interconnecting in an endless circle
said links are secured to said wheels by straps or chains
said traction penetrator operates automatically with centrifical technology principals in combination with terrain temperment
as links are strapped unto wheel there is retained a minimal amount of slack so as the drive wheels take up slack the rubber wheel grips the slider on the penetrator and slides back depressing penetrator
when terrain is soft the penetrator depresses on hard surface it retracts penetrator with opposing force
whereby said attachments to rubber wheel assemblies substantially improve traction with automatic operation
“(d)” means to design a snowmobile and ski jet and an all terrain vehicle capabilities into one unit vehicle design comprising:
a body carriage designed to travel in and out of water and unto various terrains
said carriage equipped with said undercarriage system as in claim one
whereby multiple task vehicle can be designed for recreational and commercial and military and rescue

2. a new multiple uses of undercarriage system part internal leaf spring wheel suspension by stand alone design or in combination with existing designs comprising:
“(a)” means to adapt to all kinds of various wheel designs that require suspension interlocking leaf springs encased in a circular chasis around an axle
said suspension encased in a wheel chasis and can be attached to an axle
said suspension having its own chasis and attached by sandwiching wheel chasis to suspension chasis to axle
whereby said suspension can be designed into or attached unto a multitude of chasis designs
as motorcycle and bicycle and trains and automotive and commercial and military and recreational and spacecraft
“(b)” means to adapt the internal suspension system as an impact suppressor to all kinds and various types of equippments comprising:
said means “(A)” for use as bumpers in automotive and truck docks and ship docks for side rails in automotive and hiway for tractor trailer hookup frames earthquake prone buildings for various seats and whiplash suppression and machinery
“(c)” means to adapt the internal suspension system as a vibration damper comprising:
hard rubber or reilient sleeve around an axle and said material at the ends of leafspring tips
in combination with said means “(a)” and “(b)” where minimal impact and a higher vibration damping is required for automotive and comercial and military and machinery as in a long lateral direction in jack hammer handles
“(d)” means to adapt the internal suspension as a multiple directional for all kinds of equipments and seats comprising :
three of said suspension suppressors one centered in vertically with shaft axles attached vertically one on top and one at bottom second and third of said suppressors for each axle one atop and one bottom laying horizontally
the three suppressors as one unit is attached to a chasis by the center suppressor the said units posted multipally
the chasis manipulates centered suppression unit vertically and forward and backward at 360 degree directions therefor the centered suppression unit is connected by axles which inturn manipulates the top and bottom suppressors at 360 degrees horizontally and forward and backwards whereby said units can be designed unto all kinds and various seats of commercial and military and recreational and automotive and aircraft and bicycles and motocycle and riding mowers

3. qick release pad assembly comprising:
“(a)” means to clip on and locked into place with resilient pin as a pad assembly unto chainlink
said assembly can be equipped with various various type pad materials or aditional penetrator designs whereby if a vehicle is posted in one enviroment terrian such as snow latteral blades can be clipped so giving additional traction with more penetrators.
